(19) United States
(12) Patent Application Publication
(10) Pub. No.: US 2026/0214077 A1
(43) Pub. Date: Jul. 23, 2026

(54) DATA PROCESSING METHOD, SYSTEM, AND RELATED DEVICE

(71) Applicant: HUAWEI TECHNOLOGIES CO., LTD., Shenzhen (CN)

(72) Inventors: Yinchuan Li, Shenzhen (CN); Shaoming Song, Beijing (CN); Yunfeng Shao, Beijing (CN)

(73) Assignee: HUAWEI TECHNOLOGIES CO., LTD., Shenzhen (CN)

(21) Appl. No.: 19/566,866

(22) Filed: Mar. 13, 2026

Related U.S. Application Data
(63) Continuation of application No. PCT/CN2024/096984, filed on Jun. 3, 2024.

(30) Foreign Application Priority Data
Sep. 22, 2023 (CN) 202311241182.7
Oct. 30, 2023 (CN) 202311429037.1

(51) Int. Cl. H04L 9/40; G06F 40/166

(52) U.S. Cl. CPC H04L 63/04; G06F 40/166

(57) ABSTRACT

A first device communicates with a second device over a computer network to process request information. The first device sends first request information provided by a user to the second device and receives corresponding first response information. The first device determines second request information based on the first request information or based on the first response information, and sends the second request information to the second device. Sending the second request information obfuscates an association between the user and the first request information. The first device further receives second response information corresponding to the second request information.

### CROSS-REFERENCE TO RELATED APPLICATIONS

This application is is a continuation of International Application No. PCT/CN2024/096984, filed on Jun. 3, 2024, which claims priority to Chinese Patent Application No. 202311241182.7, filed on Sep. 22, 2023 and Chinese Patent Application No. 202311429037.1, filed on Oct. 30, 2023. All of the aforementioned patent applications are hereby incorporated by reference in their entireties.

### TECHNICAL FIELD

Embodiments of this application relate to the field of artificial intelligence, and in particular, to a data processing method, a system, and a related device.

### BACKGROUND

Artificial intelligence (AI) is the theory, methodology, technology, and application systems that use digital computers or digital computer-controlled machines to simulate, extend, and enhance human intelligence, to perceive environment, obtain knowledge, and obtain an optimal result by using the knowledge. In other words, the artificial intelligence is a branch of computer science that seeks to understand the essence of intelligence and create new intelligent machines that can response in ways similar to human intelligence. AI is essentially the study of design principles and methods of various intelligent machines, enabling the machines to have perception, inference, and decision-making capabilities. Research in the field of AI includes robotics, natural language processing, computer vision, decision-making and reasoning, human-machine interaction, recommendation and search, AI basic theories, and the like.

In device-cloud scenarios, the device side sends, to the cloud side, request information (for example, a question) input by a user; the cloud side that stores a neural network performs inference and returns response information (for example, an answer) to the device side; and further, the device side presents the response information to the user. This process reveals that the request information input by the user is actually transmitted out of the user's device side, causing potential risks of privacy leakage.

Therefore, how to reduce user privacy leakage while using a cloud-side inference capability is an urgent technical problem to be resolved.

### SUMMARY

Embodiments of this application provide a data processing method and a related device, to obtain fake request information based on real request information input by a user or real response information corresponding to the real request information, so that a first unit can obfuscate the real request information by using the fake request information, and obfuscate a model by using the fake request information, thereby improving user privacy protection.

A first aspect of embodiments of this application provides a data processing method. The method may be performed by a first device/first unit, or may be performed by a component (for example, a processor, a chip, or a chip system) of the first device/first unit. The method includes: sending, to a second unit, first request information input by a user; and receiving, from the second unit, first response information corresponding to the first request information. The method further includes: sending second request information to the second unit, where the second request information is used to obfuscate the first request information; and receiving, from the second unit, second response information corresponding to the second request information. The first request information may also be understood as real request information, the first response information may also be understood as real response information, the second request information may be understood as fake request information, and the second response information may also be understood as fake response information.

In embodiments of this application, a trusted unit or device (the first unit or a third unit) obtains the fake request information, and the first unit may obfuscate the real request information by using the fake request information, so that an untrusted unit cannot determine the real request information, thereby improving user privacy protection.

In an embodiment, the foregoing operation further includes: obtaining the second request information based on the first request information.

In an embodiment, a trusted unit or device (the first unit or a third unit) obtains the fake request information corresponding to the real request information, and the first unit may use the fake request information, making it impossible for an untrusted unit to determine the real request information, thereby improving user privacy protection.

In an embodiment, the foregoing operation of obtaining the second request information based on the first request information includes: determining a first keyword in the first request information; and obtaining the second request information based on the first keyword and the first request information.

In an embodiment, the fake request information is obtained by using the first keyword, to confuse an untrusted unit by obscuring/obfuscating the keyword, so that the untrusted unit cannot determine the real request information, thereby improving user privacy protection.

In an embodiment of the first aspect, the foregoing operation of obtaining the second request information based on the first keyword and the first request information includes: determining a first replacement word corresponding to the first keyword; and replacing the first keyword in the first request information with the first replacement word to obtain the second request information.

In an embodiment, the related first replacement word is obtained by using the first keyword, and the first keyword in the first request information is replaced with the first replacement word, so that the first keyword can be hidden and obfuscated, thereby reducing a risk of the first keyword being identified by an untrusted unit, and improving user privacy.

In an embodiment, the foregoing operation of obtaining the second request information based on the first keyword and the first request information includes: sending the first keyword and the first request information to a third unit; and receiving the second request information sent by the third unit.

In an embodiment, a trusted unit (namely, the third unit) generates the fake request information, so that the real request information can be hidden from an untrusted unit, thereby improving user privacy.

In an embodiment, the foregoing operation of determining the first keyword in the first request information includes: determining the first keyword based on a first operation of the user or a first preset rule.

In an embodiment, there are a plurality of manners of determining the keyword, and the keyword may be selected based on the operation of the user or the preset rule, thereby expanding an application scope of the solution.

In an embodiment, the foregoing operation of obtaining the second request information based on the first request information includes: sending the first request information to a third unit; and receiving the second request information sent by the third unit.

In an embodiment, a trusted unit (namely, the third unit) generates the fake request information, so that the real request information can be hidden from an untrusted unit, thereby improving user privacy.

In an embodiment, the foregoing operation further includes: generating the second request information based on the first response information.

In an embodiment, the real response information is first obtained by using the real request information, and then a plurality of pieces of fake request information are obtained based on the real response information. Generally, the second unit retrieves a log or the like in a specified period of time, provided that the second unit infers that a time interval between the real request information and the fake request information is less than the period of time. In terms of log representation, the first unit may obfuscate the real request information by using the plurality of pieces of fake request information, thereby improving user privacy protection.

In an embodiment, the foregoing operation of generating the second request information based on the first response information includes: obtaining third response information based on the first response information; and obtaining the second request information based on the third response information.

In an embodiment, the real response information is first obtained by using the real request information, and then a plurality of pieces of fake response information are obtained by obfuscating the real response information, so that a plurality of pieces of fake request information can be obtained by performing reverse inference on the plurality of pieces of fake response information. Generally, the second unit retrieves a log or the like in a specified period of time, provided that the second unit infers that a time interval between the real request information and the fake request information is less than the period of time. In terms of log representation, the first unit may obfuscate the real request information by using the plurality of pieces of fake request information, thereby improving user privacy protection.

In an embodiment, the foregoing operation of obtaining the third response information based on the first response information includes: determining a second keyword in the first response information; determining a second replacement word corresponding to the second keyword; and replacing the second keyword in the first response information with the second replacement word to obtain the third response information.

In an embodiment, a plurality of pieces of fake request information are obtained based on the second keyword in a real result. Generally, the second unit retrieves a log or the like in a specified period of time, provided that the second unit infers that a time interval between the real request information and the fake request information is less than the period of time. In terms of log representation, the first unit may obfuscate the real request information by using the plurality of pieces of fake request information, thereby improving user privacy protection.

In an embodiment, the foregoing operation further includes: presenting a plurality of pieces of response information or the first response information to the user, where the plurality of pieces of response information include the first response information and the second response information.

In an embodiment, it may be convenient for the user to use the second unit to perform data processing to obtain the response information required by the user, thereby improving user experience.

In an embodiment, the foregoing operation further includes: receiving the first request information sent by a third unit; and sending a plurality of pieces of response information or the first response information to the third unit, where the plurality of pieces of response information include the first response information and the second response information.

In an embodiment, the third unit used by the user may obtain the response information by using the trusted first unit, to provide the response information required by the user, thereby improving user experience.

In an embodiment, the first unit or the first device is a question-answering device.

In an embodiment, the first unit may be a question-answering device that provides a request service for the user. The user may ask a question to the question-answering device, and receive an answer fed back by the question-answering device, to provide the answer required by the user, thereby improving user experience.

In an embodiment, the first request information includes at least one of the following: a question, a word processing request, and a translation request.

In an embodiment, the first request information may provide a plurality of requirements for the user, thereby improving flexibility of the solution.

A second aspect of embodiments of this application provides a data processing method. The method may be performed by a third device/third unit, or may be performed by a component (for example, a processor, a chip, or a chip system) of the third device/third unit. The method includes: receiving first request information sent by a first unit or first response information corresponding to the first request information; and sending second request information to the first unit based on the first request information or the first response information, where the second request information is used to obfuscate the first request information.

In embodiments of this application, a trusted unit or device (the third unit) obtains fake request information based on real request information or real response information, and the real request information may be obfuscated by using the fake request information, so that an untrusted unit cannot determine the real request information, thereby improving user privacy protection. In an embodiment, the third device/third unit is deployed on a network server, and the first unit is deployed on a terminal device.

In an embodiment, the trusted network server determines the second request information for the terminal device, and the terminal device may obfuscate real request information by using fake request information, so that an untrusted second unit cannot determine the real request information, thereby improving user privacy protection.

In an embodiment, the foregoing operation of sending the second request information to the first unit based on the first request information or the first response information includes: obtaining the second request information based on the first request information or the first response information; and sending the second request information to the first unit.

In an embodiment, a trusted unit or device (the third unit) obtains fake request information based on real request information or real response information, and sends the second request information to the first unit. Therefore, subsequently, the first unit may obfuscate the real request information by using the fake request information, thereby reducing a risk of the real request information being identified by an untrusted unit.

A third aspect of embodiments of this application provides a data processing method. The method may be jointly performed by a first unit and a third unit, or may be performed by a component (for example, a processor, a chip, or a chip system) of the first unit and a component (for example, a processor, a chip, or a chip system) of the third unit. In the method, the first unit sends, to a second unit, first request information input by a user; the second unit sends, to the first unit, first response information corresponding to the first request information; the second unit receives second request information sent by the first unit, where the second request information is used to obfuscate the first request information; and the first unit receives, from the second unit, second response information corresponding to the second request information.

In embodiments of this application, the trusted first unit sends real request information and fake request information to the untrusted second unit, and the first unit may use the fake request information, making it impossible for the untrusted second unit to determine the real request information, thereby improving user privacy protection.

In an embodiment, the foregoing operation further includes: The first unit obtains the second request information based on the first request information or the first response information.

In an embodiment, the trusted first unit obtains fake request information corresponding to real request information, and the first unit may obfuscate the real request information by using the fake request information, so that an untrusted unit cannot determine the real request information, thereby improving user privacy protection.

In an embodiment, the foregoing operation further includes: The first unit obtains the second request information based on the first response information.

In an embodiment, real response information is first obtained by using real request information, and then a plurality of pieces of fake request information are obtained based on the real response information. Generally, the second unit retrieves a log or the like in a specified period of time, provided that the second unit infers that a time interval between the real request information and the fake request information is less than the period of time. In terms of log representation, the first unit may obfuscate the real request information by using the plurality of pieces of fake request information, thereby improving user privacy protection.

A fourth aspect of embodiments of this application provides a first device. The first device includes: a transceiver unit, configured to send, to a second unit, first request information input by a user. The transceiver unit is further configured to receive, from the second unit, first response information corresponding to the first request information; the transceiver unit is further configured to send second request information to the second unit, where the second request information is used to obfuscate the first request information; and the transceiver unit is further configured to receive, from the second unit, second response information corresponding to the second request information.

In an embodiment, the first device further includes a processing unit, configured to obtain the second request information based on the first request information.

In an embodiment, the processing unit is configured to determine a first keyword in the first request information; and the processing unit is configured to obtain the second request information based on the first keyword and the first request information.

In an embodiment, the processing unit is configured to determine a first replacement word corresponding to the first keyword; and the processing unit is configured to replace the first keyword in the first request information with the first replacement word to obtain the second request information.

In an embodiment, the processing unit is configured to send the first keyword and the first request information to a third unit; and the processing unit is configured to receive the second request information sent by the third unit.

In an embodiment, the processing unit is configured to determine the first keyword based on a first operation of the user or a first preset rule.

In an embodiment, the processing unit is configured to send the first request information to a third unit; and the processing unit is configured to receive the second request information sent by the third unit.

In an embodiment, the first device further includes a processing unit, configured to generate the second request information based on the first response information.

In an embodiment, the processing unit is configured to obtain third response information based on the first response information; and the processing unit is configured to obtain the second request information based on the third response information.

In an embodiment, the processing unit is configured to determine a second keyword in the first response information; the processing unit is configured to determine a second replacement word corresponding to the second keyword; and the processing unit is configured to replace the second keyword in the first response information with the second replacement word to obtain the third response information.

In an embodiment, the first device further includes a presentation unit, configured to present a plurality of pieces of response information or the first response information to the user, where the plurality of pieces of response information include the first response information and the second response information.

In an embodiment, the transceiver unit is further configured to receive the first request information sent by a third unit; and the transceiver unit is further configured to send a plurality of pieces of response information or the first response information to the third unit, where the plurality of pieces of response information include the first response information and the second response information.

In an embodiment, the first unit or the first device is a question-answering device.

In an embodiment, the first request information includes at least one of the following: a question, a word processing request, and a translation request.

A fifth aspect of embodiments of this application provides a third device. The third device includes: a transceiver unit, configured to receive first request information sent by a first unit or first response information corresponding to the first request information. The transceiver unit is further configured to send second request information to the first unit based on the first request information or the first response information, where the second request information is used to obfuscate the first request information.

In an embodiment, the third device is deployed on a network server, and the first unit is deployed on a terminal device.

In an embodiment, the transceiver unit is configured to obtain the second request information based on the first request information or the first response information; and the transceiver unit is configured to send the second request information to the first unit.

A sixth aspect of embodiments of this application provides a first device, including a processor. The processor is coupled to a memory, and the memory is configured to store a program or instructions. When the program or the instructions are executed by the processor, the first device is caused to implement the method according to any one of the first aspect or the possible embodiments of the first aspect.

A seventh aspect of embodiments of this application provides a third device, including a processor. The processor is coupled to a memory, and the memory is configured to store a program or instructions. When the program or the instructions are executed by the processor, the third device is caused to implement the method according to any one of the possible embodiments of the second aspect.

An eighth aspect of embodiments of this application provides a communication system. The communication system includes the first unit in the first aspect and the second unit in the first aspect, or the communication system includes the first unit in the first aspect, the second unit in the first aspect, and the third unit in the second aspect, or the communication system includes the first device in the fourth aspect and the third device in the fifth aspect.

A ninth aspect of embodiments of this application provides a communication system. The communication system includes a first unit and a second unit.

The first unit is configured to send, to the second unit, first request information input by a user.

The second unit is configured to send, to the first unit, first response information corresponding to the first request information.

The second unit is further configured to receive second request information sent by the first unit, where the second request information is used to obfuscate the first request information.

The first unit is further configured to receive, from the second unit, second response information corresponding to the second request information.

A tenth aspect of embodiments of this application provides a computer-readable medium. The computer-readable medium stores a computer program or instructions. When the computer program or the instructions are run on a computer, the computer is caused to perform the method according to any one of the possible embodiments of any one of the first aspect to the third aspect.

An eleventh aspect of embodiments of this application provides a computer program product. When the computer program product runs on a computer, the computer is caused to perform the method according to any one of the possible embodiments of any one of the first aspect to the third aspect.

A twelfth aspect of embodiments of this application provides a chip system. The chip system includes at least one processor, configured to support a data processing device in implementing a function in any one of the possible embodiments of any one of the first aspect to the third aspect.

In an embodiment, the chip system may further include a memory. The memory is configured to store program instructions and data that are necessary for the data processing device. The chip system may include a chip, or may include a chip and another discrete component. In an embodiment, the chip system further includes an interface circuit, and the interface circuit provides program instructions and/or data for the at least one processor.

For technical effects of the fourth aspect to the twelfth aspect, refer to technical effects brought by any one of the first aspect to the third aspect. Details are not described herein again.

It can be learned from the foregoing technical solutions that, embodiments of this application have the following advantages: A trusted unit or device (a first unit or a third unit) obtains fake request information, and the first unit may obfuscate real request information by using the fake request information, so that an untrusted unit cannot determine the real request information, thereby improving user privacy protection.

### BRIEF DESCRIPTION OF DRAWINGS

FIG. 1A is a diagram of a system architecture according to an embodiment of this application;

FIG. 1B is another diagram of a system architecture according to an embodiment of this application;

FIG. 1C is another diagram of a system architecture according to an embodiment of this application;

FIG. 2 is a schematic flowchart of a data processing method according to an embodiment of this application;

FIG. 3A is an example diagram of a user interface displayed by a first unit according to an embodiment of this application;

FIG. 3B is an example diagram of another user interface displayed by a first unit according to an embodiment of this application;

FIG. 3C is an example diagram of another user interface displayed by a first unit according to an embodiment of this application;

FIG. 4A is an example diagram of another user interface displayed by a first unit according to an embodiment of this application;

FIG. 4B is an example diagram of another user interface displayed by a first unit according to an embodiment of this application;

FIG. 5 is another schematic flowchart of a data processing method according to an embodiment of this application;

FIG. 6 is another schematic flowchart of a data processing method according to an embodiment of this application;

FIG. 7 is another schematic flowchart of a data processing method according to an embodiment of this application;

FIG. 8 is another schematic flowchart of a data processing method according to an embodiment of this application;

FIG. 9 is another schematic flowchart of a data processing method according to an embodiment of this application;

FIG. 10 is another schematic flowchart of a data processing method according to an embodiment of this application;

FIG. 11 is another schematic flowchart of a data processing method according to an embodiment of this application;

FIG. 12 is a diagram of a structure of a data processing device according to an embodiment of this application;

FIG. 13 is a diagram of a structure of a first device according to an embodiment of this application; and

FIG. 14 is a diagram of another structure of a data processing device according to an embodiment of this application.

### DESCRIPTION OF EMBODIMENTS

Embodiments of this application provide a data processing method and a related device, to obtain fake request information based on real request information input by a user or real response information corresponding to the real request information, so that the real request information is obfuscated by using the fake request information, and a model is obfuscated by using the fake request information, thereby improving user privacy protection.

For ease of understanding, the following first describes related terms and concepts mainly used in embodiments of this application.

### 1. Neural Network (Also Referred to as a Model)

The neural network may be composed of neural units. The neural unit may be an operation unit with a weight as Wₛ and a bias as b. An output of the operation unit may be:

$${h}_{W , b} ( x ) = f ( {W}^{T} x ) = f ( {\sum }_{s = I}^{n} {W}_{s} {x}_{s} + b ) .$$

s=1, 2, . . . , n, n is a natural number greater than 1, Wₛ is the weight of Xₛ, and b is the basis of the neural unit. f is an activation function of the neural unit, and is used to introduce a non-linear feature into the neural network to convert an input signal in the neural unit into an output signal. The output signal of the activation function may serve as an input of a next convolutional layer. The activation function may be a sigmoid function. The neural network is a network formed by connecting many single neural units together. In an embodiment, an output of a neural unit may be an input of another neural unit. An input of each neural unit may be connected to a local receptive field of a previous layer to extract a feature of the local receptive field. The local receptive field may be a region including several neural units.

### 2. Loss Function

During the training of a deep neural network, the goal is to make an output of the deep neural network as close as possible to an expected predicted value. To achieve this, a predicted value of a current network and an expected target value may be compared, and then a weight vector of each layer of the neural network is updated based on discrepancy between the predicted value and the target value (certainly, before the first update, there is usually an initialization process in which parameters are preconfigured for all layers of the deep neural network). For example, if the predicted value of the network is too high, the weight vector is adjusted to decrease the predicted value. This process of adjustment is repeated until the neural network can output the expected target value. Therefore, “how to compare the predicted value and the target value” needs to be predefined; this is the role of a loss function or an objective function. These functions are important equations for measuring the discrepancy between the predicted value and the target value. For instance, in terms of the loss function, a higher output value (loss) of the loss function indicates a larger discrepancy. Therefore, training of the deep neural network is a process of minimizing the loss as much as possible.

### 3. Trusted Unit/Device and Untrusted Unit/Device

In this application, “trusted” and “untrusted” are relative concepts. The “trusted unit/device” refers to a unit/device trusted by a user. In this application, it is considered by default that the “trusted unit/device” learns of user privacy and does not leak the user privacy or cause a privacy leakage risk to the user. The “trusted unit/device” may be set by the user, or may be determined through third-party check or the like, or may be a unit/device used by the user for a long time. On the contrary, the “untrusted unit/device” refers to a unit/device that is not trusted by a user. In this application, it is considered by default that the “untrusted unit/device” learns of user privacy and may leak the user privacy or cause a potential risk of privacy leakage. The “untrusted unit/device” may be set by the user, or may be determined through third-party check or the like, or may be a unit/device that has not been used by the user.

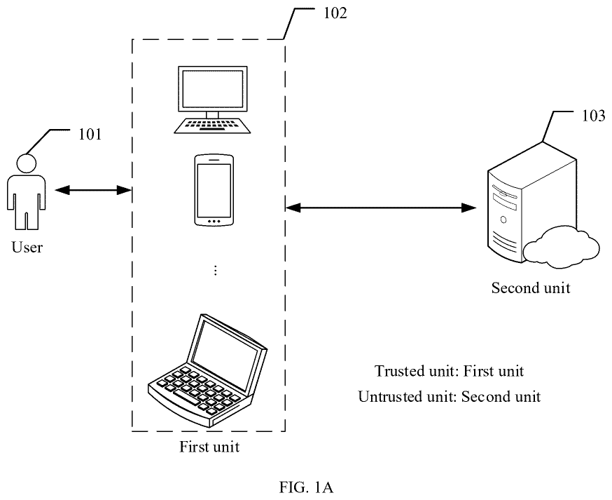

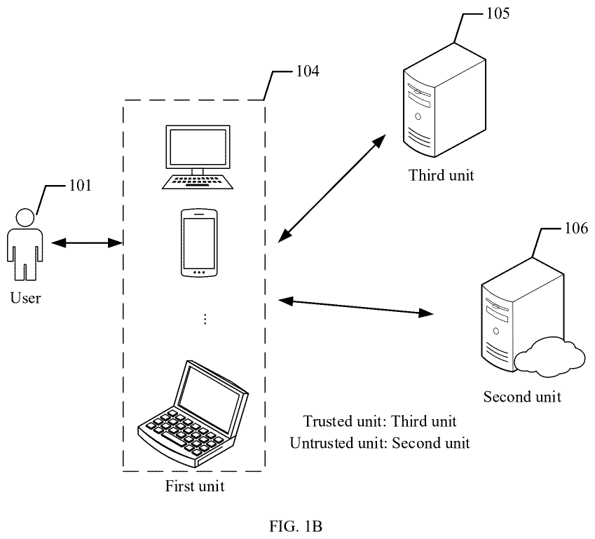

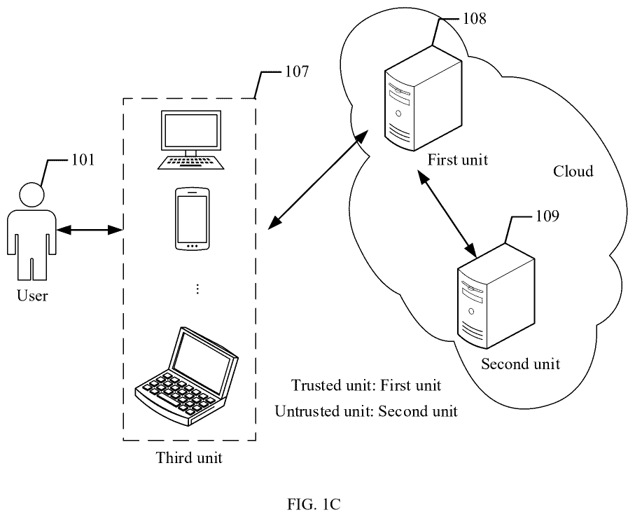

Refer to FIG. 1A. An embodiment of the present invention provides a system architecture. The system architecture includes: a user 101, a first unit 102, and a second unit 103.

The user 101 may be understood as a user of the first unit 102, and the user 101 may operate the first unit 102 by using an operation such as a voice/touch gesture. In a process in which the user 101 uses the first unit 102, the first unit 102 may independently serve the user 101, or may collaborate with another device (for example, a third unit 105) for processing to serve the user 101.

The first unit 102 is configured to serve the user 101. The first unit 102 may be equipped with an operating system and have an application program installed based on an operation of the user 101. The first unit 102 may support at least one of the following functions: installing an application program, invoking a cloud service (for example, a public cloud or a private cloud), providing a built-in service, and the like.

The second unit 103 stores a processing module, and may process data to obtain a processing result. Alternatively, it is understood as that the second unit 103 has a data processing function, and the data processing function may also be understood as processing a user request (for example, a question request, a classification request, a segmentation request, a detection request, or an image generation request). The processing module may implement the data processing function by using a method such as machine learning. The machine learning includes a neural network, an expert system, symbol inference, a decision tree, a support vector machine, and the like.

For ease of description, an example in which the processing module performs data processing over the neural network is used for subsequent description. It may be understood that during actual application, the processing module in the second unit may further implement the data processing function in another manner included in the machine learning. This is not limited herein.

In an embodiment, the user 101 enters request information to the first unit 102, and the first unit 102 sends the request information to the second unit 103. The second unit 103 performs data processing on the request information over the neural network to obtain response information, and returns the response information to the first unit 102. Therefore, the first unit 102 may display the response information to the user 101.

When the neural network stored in the second unit 103 is a large language model (large language model, LLM), because the model has a very powerful inference capability but is limited by factors such as training data, to better obtain an effective inference result, a series of processing operations need to be performed on the entered request information (in other words, input data of the neural network). These processing operations include but are not limited to the following.
(1) Introduce external knowledge (through searching or using a knowledge base): A searching engine, a vector knowledge base, or the like is used to retrieve professional knowledge related to a question, and a prompt is formed by combining the professional knowledge and question content and is input into the model to obtain the response information, thereby improving reliability of domain-specific knowledge in an answer.
(2) Decompose the request information/Use the chain of thought: For excessive long and complex request information, the large model cannot directly process the request information that requires a strong inference capability. Therefore, the request information can be properly decomposed, and the complex request information may be decomposed into a series of simple request information combinations, which are gradually processed by the model.
(3) Apply a new template to control the response information: For some request information, features of the large model may be used to embed the request information into one or more templates, and model outputs are required to meet specified requirements.

The foregoing processing operations are collectively referred to as prompt engineering, which is one of the best methods for processing the request information and obtaining effective response information by using the large language model.

Because the large language model has a very high requirement on inference computing power, currently, most users complete use of the large model by using a capability of a model (namely, the neural network in the second unit 103 shown in FIG. 1A) mounted to a cloud service. Consequently, request information of a user and corresponding response information are actually transmitted to the outside of a local device (namely, the first unit 102 shown in FIG. 1A) of the user. This brings a series of problems and potential risks, including but not limited to the following.
(1) User privacy data is used for model training. Training of the large model depends on high-quality corpuses. Currently, many commercial models use the request information of the user and the response information as training corpuses and internalize the training corpuses into model capabilities. Consequently, user data is stored on a service provider side for a long time, causing unknown risks.
(2) The user privacy data is leaked in the model. As mentioned in (1), the user data is used for training. Therefore, in an inference process, the user privacy data may be leaked when being trained by other users. Attackers can steal or reconstruct LLM training data by using a technology such as model extraction, model inversion, or membership inference.
(3) A user portrait is constructed based on the request information of the user. Based on information such as a historical request of the user, a service provider can construct the user portrait to provide a series of services such as advertisement push.

The foregoing behavior causes great impact on privacy security of the user data. Due to the variety of models and the lack of clear oversight in the large model field, it is difficult for the user to identify safe model services and unsafe model services. Therefore, some technologies are needed to avoid user privacy leakage to the maximum extent while the model capabilities can still be normally used.

In a process of using an inference service of the large model, an untrusted service provider (namely, the second unit 103 shown in FIG. 1A) can completely obtain questions and answers. Using these answers for training a model of the untrusted service provider or for other purposes seriously infringes user privacy. Based on this assumption, a method is needed to prevent the untrusted service provider from obtaining and using real request information of the user and response information, without affecting the user obtaining expected response information on a user side.

The conventional technology mainly focuses on how to protect a model on a server from being corrupted by maliciously poisoned data, or focuses on avoiding privacy leakage to some extent by replacing content of the request information of the user and sacrificing accuracy of the request information. This is based on that the service provider is trustworthy, or this causes great impact on performance of the response information of the request information. Therefore, a method for preventing data from being used for other purposes and ensuring that the original response information can be obtained is necessary.

The following uses several conventional technologies as examples to describe existing problems.

Example 1: The paper Privacy-Preserving Prompt Tuning for Large Language Model Services proposes an RAPT (privacy-preserving prompt tuning) method, which prevents, through local differential privacy and user-specified tuning on the server, intruders from obtaining privacy information locally and in a cloud by embedding inversion attacks and attribute inference attacks.

The disadvantage of this method is as follows: In addition to a decrease in accuracy of information that may be introduced on a differential privacy side, this framework assumes that the service provider is reliable, which invalidates a privacy protection function in a specified scenario.

Example 2: Sensitive information such as user privacy is replaced with general entity information (such as a name and a birthday) for questioning, to avoid privacy leakage.

The advantage of this method is that privacy leakage can be avoided. However, excessive entity masking greatly reduces accuracy (for example, when a birthday is provided for calculating some dates, masking the birthday makes it impossible to perform any calculation).

To resolve the foregoing technical problems, a trusted unit or device obtains fake request information based on real request information input by a user or real response information corresponding to the real request information, obfuscates the real request information by using the fake request information, and obfuscates a model by using the fake request information, thereby improving user privacy protection.

System architectures to which a method provided in embodiments of this application is applicable are first described.

A first type is the system architecture shown in FIG. 1A.

In the system architecture shown in FIG. 1A, if the first unit 102 is a trusted unit, the first unit 102 may process real request information input by the user 101 to obtain a plurality of pieces of fake request information, to send the real request information and the plurality of pieces of fake request information to the second unit 103. The second unit 103 performs inference on the real request information and the plurality of pieces of fake request information by using a large model to obtain a plurality of pieces of response information.

In this case, for the second unit 103, in addition to the real request information, the request information received by the second unit 103 further includes the plurality of pieces of fake request information. Therefore, the second unit 103 cannot determine which piece of received request information is the real request information, thereby improving user privacy protection.

A second type is a system architecture shown in FIG. 1B.

In the system architecture shown in FIG. 1B, the system architecture includes a user 101, a first unit 104, a third unit 105, and a second unit 106. The third unit 105 cannot directly communicate with the second unit 106, and the first unit 104 needs to be used as an intermediary. Compared with the system architecture in FIG. 1A, in the system architecture shown in FIG. 1B, a trusted unit, namely, the third unit 105, is added. The first unit 104 obtains real request information input by the user 101, and sends the real request information to the third unit 105. The third unit 105 processes the real request information to obtain a plurality of pieces of fake request information, and returns the plurality of pieces of fake request information to the first unit 104. The first unit 104 sends the real request information and the plurality of pieces of fake request information to the second unit 106, and the second unit 106 performs inference on the real request information and the plurality of pieces of fake request information by using a large model to obtain a plurality of pieces of response information, and returns the plurality of pieces of response information to the first unit 104. The first unit 104 may directly display the plurality of pieces of response information or real response information to the user 101, or may perform some processing (for example, selection, rendering, and format conversion) on the plurality of pieces of response information or the real response information, and then present processed response information to the user 101.

In this case, the trusted third unit 105 obfuscates the real request information. For the second unit 106, in addition to the real request information, request information received by the second unit 106 further includes the plurality of pieces of fake request information. Therefore, the second unit 106 cannot determine which piece of received request information is the real request information, thereby improving user privacy protection.

A third type is a system architecture shown in FIG. 1C.

In the system architecture shown in FIG. 1C, the system architecture includes a user 101, a third unit 107, a first unit 108, and a second unit 109. In addition, the first unit 108 and the second unit 109 are in a same cloud (as shown in FIG. 1C). In this case, the third unit 107 obtains real request information input by the user, and sends the real request information to the first unit 108. After processing the real request information to obtain a plurality of pieces of fake request information, the first unit 108 may directly send the real request information and the plurality of pieces of fake request information to the second unit 109. The second unit 109 performs inference on the real request information and the plurality of pieces of fake request information by using a large model to obtain a plurality of pieces of response information, and returns the plurality of pieces of response information to the first unit 108. The first unit 108 may directly return the plurality of pieces of response information to the third unit 107. The third unit 107 may directly present the plurality of pieces of response information to the user 101, or may select real response information from the plurality of pieces of response information and present the real response information to the user 101. Certainly, alternatively, the first unit 108 may select the real response information from the plurality of pieces of response information, and send the real response information to the third unit 107, so that the third unit 107 presents the real response information to the user 101. That is, the operation of selecting the real response information may be performed by the third unit 107, or may be performed by the first unit 108. This is not limited herein.

It may be understood that the foregoing request information or data may be a text, an image, an audio, a video, or the like. In addition, quantities of users and devices in the system architectures shown in FIG. 1A to FIG. 1C are not limited, in other words, there may be more users, first units, and third units. In addition, the system architectures in FIG. 1A to FIG. 1C are merely examples. During actual application, the method provided in embodiments of this application may be further applied to another architecture. This is not limited herein.

It may be understood that, the units in the system architectures shown in FIG. 1A to FIG. 1C are merely shown by using an example in which the units belong to different physical devices. During actual application, the units in the system architectures shown in FIG. 1A to FIG. 1C may each belong to an independent physical device, or two units may belong to a same physical device. This is not limited herein. For example, the first unit is deployed on a first device, the second unit is deployed on a second device, and the third unit is deployed on a third device. For another example, the first unit is deployed on a first device, and the second unit and the third unit are deployed on a same physical device or platform. For another example, the second unit is a plug-in (for example, a pluggable component such as a USB key or a USB flash drive) of a first device.

In embodiments of this application, the first unit in the system architectures shown in FIG. 1A and FIG. 1B or the third unit in the system architecture shown in FIG. 1C may be a terminal device or a question-answering device that serves the user 101. The terminal device may be deployed on land, including an indoor device, an outdoor device, a handheld device, a wearable device, or a vehicle-mounted device; may be deployed on a water surface (for example, on a ship); or may be deployed in the air (for example, on a plane, a balloon, and a satellite). The terminal device may be a mobile phone (for example, a foldable phone or a non-foldable phone), a tablet computer (Pad), a computer having a wireless transceiver function, a virtual reality (VR) terminal device, an augmented reality (AR) terminal device, a wireless terminal in industrial control, a vehicle-mounted terminal device, a wireless terminal in self driving, a wireless terminal in remote medical, a wireless terminal in smart grid, a wireless terminal in transportation safety, a wireless terminal in smart city, a wireless terminal in smart home, a wearable terminal device, or the like. An application scenario is not limited in embodiments of this application. The terminal device sometimes may also be referred to as a terminal, user equipment (UE), an access terminal device, a vehicle-mounted terminal, an industrial control terminal, a UE unit, a UE station, a mobile station, a remote station, a remote terminal device, a mobile device, a UE agent, a UE apparatus, or the like. The terminal device may be fixed or mobile.

The second unit in embodiments of this application is an untrusted unit, and is a device or a server that can perform data processing over a neural network. For example, the second unit may be a device or a server that has a data processing function, for example, a cloud server, a network server, an application server, a management server, or a wireless controller.

The first unit and the third unit in embodiments of this application are trusted units, and are devices or servers that can obfuscate the real request information. For example, the third unit in the system architecture shown in FIG. 1B may be a device or a server that can obfuscate the real request information, for example, an agent device, a cloud server, a network server, an application server, a management server, or a wireless controller.

The following describes the data processing method provided in embodiments of this application with reference to the system architectures in FIG. 1A to FIG. 1C.

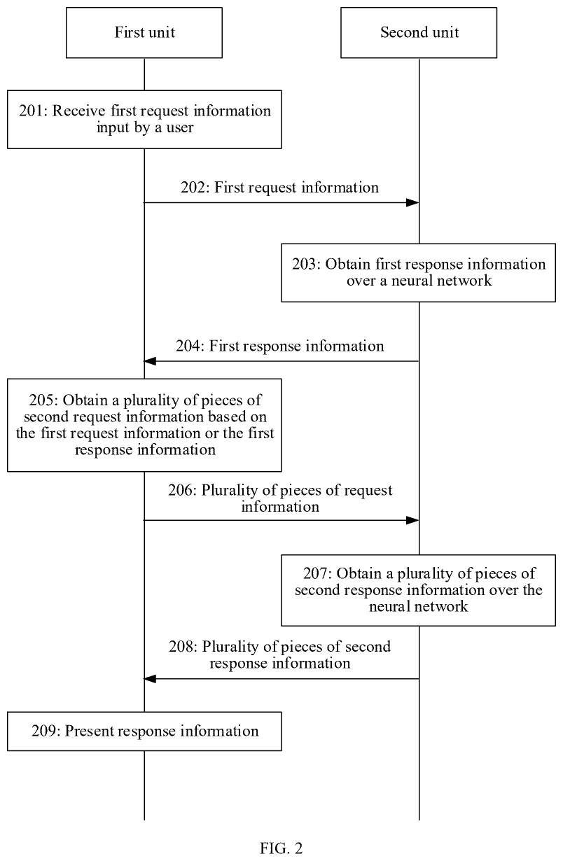

FIG. 2 is a schematic flowchart of a data processing method according to an embodiment of this application. The method may include operation 201 to operation 209. The following describes operation 201 to operation 209 in detail. The method shown in FIG. 2 may be applied to any one of the system architectures shown in FIG. 1A to FIG. 1C.

Operation 201: A first unit receives first request information input by a user.

The first unit receives the first request information input by the user. In this embodiment of this application, the first request information may also be understood as request information input by the user, and may be a question (also referred to as a query) input/selected by the user, a word processing request (for example, a summary analysis request) input/selected by the user, a translation request input/selected by the user, or the like. This is not limited herein. In addition, in this embodiment of this application, the request information (for example, the first request information or second request information) may be carried in a text, an image, a voice, or the like. This is not limited herein.

For ease of understanding, in this embodiment of this application, the first request information may be understood as real request information, the second request information may also be understood as fake request information, first response information may also be understood as real response information, and second response information may also be understood as fake response information.

In this embodiment of this application, the first unit obtains the first request information in a plurality of manners. The user may directly enter the first request information to the first unit (by using, for example, a keyboard or a voice), or the first request information may be selected (for example, selected or typed) by the user in an interface displayed by the first unit, or the first request information may be selected from a database, or the first request information may be received through forwarding by another device (for example, in FIG. 1C, the first unit may receive the first request information forwarded by the third unit). This is not limited herein.

In an embodiment, the user may directly enter the first request information to the first unit by using a peripheral device (for example, a USB flash drive, a keyboard, or a mouse).

In an embodiment, the first unit may determine the first request information based on an operation of the user. For example, the first unit displays the interface to the user, where the interface includes a plurality of options, and then the first unit determines the first request information based on operations (for example, a tap selection operation and a voice operation) performed by the user on the plurality of options.

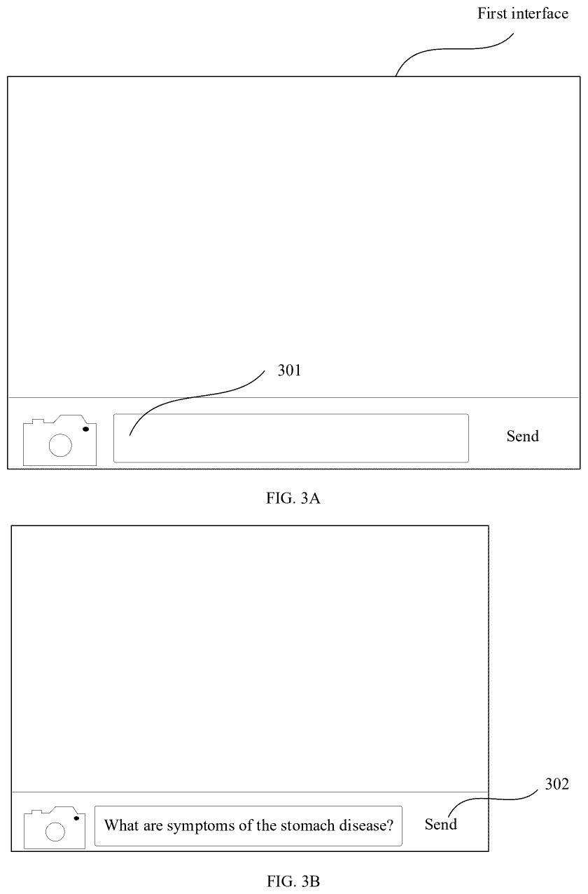

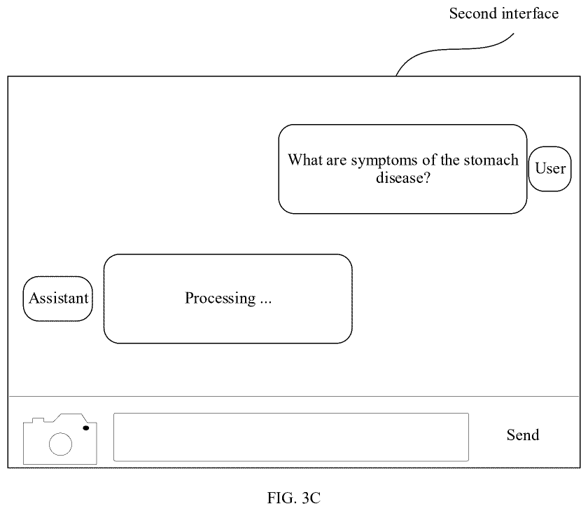

Example 1: The first request information is a question and is carried in a text. The first request information is: What are symptoms of the stomach disease? In this example, an example in which the first unit obtains the first request information may be shown in FIG. 3A to FIG. 3C. The first unit first displays a first interface shown in FIG. 3A to the user, and an area 301 in the first interface is used by the user to enter the request information. After the user enters the request information in the area 301, as shown in FIG. 3B, the user may transmit the request information to the first unit in a manner of tapping a send bottom 302. After receiving the request information input by the user, the first unit may display a second interface shown in FIG. 3C. The second interface includes the request information input by a user window, a prompt of “processing” of an assistant window, and the like. It may be understood that FIG. 3C may alternatively not include the prompt of “processing” of the assistant window. This is not limited herein.

Example 2: The first request information is: How to lose weight when the weight is 100 kilograms?

Operation 202: The first unit sends the first request information to a second unit.

After obtaining the first request information, the first unit may send the first request information to the second unit. Correspondingly, the second unit receives the first request information sent by the first unit.

Operation 203: The second unit obtains the first response information over a neural network.

After obtaining the first request information, the second unit obtains the first response information over the neural network. For example, the first request information is a question, and the first response information may also be understood as an answer.

For ease of understanding, the foregoing first response information may be understood as real response information.

In this embodiment of this application, the neural network may be a convolutional neural network (CNN), a feedforward neural network (FNN), a recursive neural network (RNN) (for example, a long short-term memory network, a gated recurrent unit, or an attention network), a transformer, a generative adversarial network (GAN), an LLM, or the like. A structure, type, and training manner of the neural network may vary and are not limited in embodiments of this application.

In an embodiment, the second unit inputs the first request information into the neural network to obtain the first response information.

Operation 204: The second unit sends the first response information to the first unit.

After obtaining the first response information, the second unit sends the first response information to the first unit. Correspondingly, the first unit receives the first response information sent by the second unit.

Operation 205: The first unit obtains the second request information based on the first request information or the first response information.

In this embodiment of this application, there may be one or more pieces of second request information. It may be understood that, to improve an obfuscating effect, there are usually a plurality of pieces of second request information, and the plurality of pieces of second request information are also used as an example for subsequent description.

In this embodiment of this application, the second request information is used to obfuscate the first request information, or it is understood as that the first request information is real request information input by the user, and the second request information is fake request information constructed based on the real request information or real response information corresponding to the real request information.

In an embodiment, a case of the second request information is similar to that of the first request information. The second request information may be a question (which may also be referred to as a question), a word processing request (for example, a summary analysis request), a translation request, or the like. This is not limited herein.

Generally, a task of the second request information is the same as or similar to a task of the first request information, or the second request information and the first request information partially overlap. For example, the first request information is: What are symptoms of the stomach disease? The second request information includes: What are symptoms of the liver disease? In this example, the task of the first request information is similar to the task of the second request information (for example, the task is to inquire about the symptoms). For another example, the first request information is: What are symptoms of the stomach disease? The second request information includes: Which hospitals offer treatment for the stomach disease? In this example, the first request information and the second request information partially overlap (for example, both are questions for the stomach disease).

There are a plurality of cases for this operation, which are described separately in the following.

In a first case, the first unit obtains a plurality of pieces of second request information based on the first request information.

This case may be understood as follows: In this embodiment, the first request information and the plurality of pieces of second request information are carried in a same message, and the first response information and a plurality of pieces of second response information are carried in a same message. In other words, it may be understood as that the first unit may simultaneously send the first request information and the plurality of pieces of second request information to the second unit, and the second unit may simultaneously send the first response information and the plurality of pieces of second response information to the first unit.

In this embodiment of this application, the first unit may obtain the plurality of pieces of second request information based on the first request information and a keyword. The first unit may alternatively obtain the plurality of pieces of second request information based on the first request information using a preset rule. The first unit may alternatively send the first request information to another unit, and receive the plurality of pieces of second request information fed back by the another unit. The first unit may alternatively obtain the plurality of pieces of second request information based on the first request information and an operation of the user. This is not limited herein. The following uses only an example in which the first unit obtains the plurality of pieces of second request information based on the first request information and the keyword for description.

In this embodiment of this application, the first unit determines the keyword in a plurality of manners. The first unit may determine the keyword based on a selection operation of the user, or may determine the keyword according to a first preset rule, or another device may forward the keyword determined by the user, or the first unit may send the first request information to another device (for example, the third unit), and the another device determines the keyword and returns the keyword to the first unit (for example, in FIG. 1C, the first unit may receive the keyword forwarded by the third unit). This is not limited herein.

The first preset rule may be related to at least one of the following words that involve user privacy, such as a name, an address, a place of birth, a job, a company name, a number, a date, a sentence composition (for example, a subject, a predicate, an object, or an attributive), a magnitude unit, a noun, a verb, an adjective, an adverb representing a degree, a color, a sport, and a disease name. This is not limited herein.

In an embodiment, the keyword is a word (which may also be referred to as a first keyword in this case) in the first request information. After obtaining the first request information, the first unit may first determine the first keyword in the first request information, and then obtain the plurality of pieces of second request information based on the first keyword and the first request information.

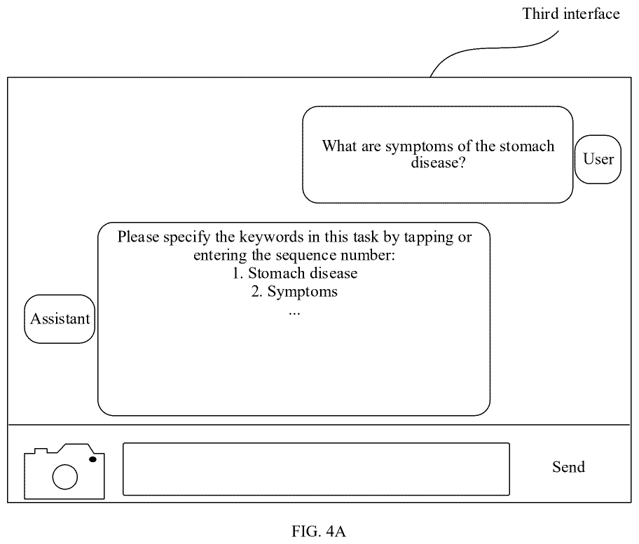

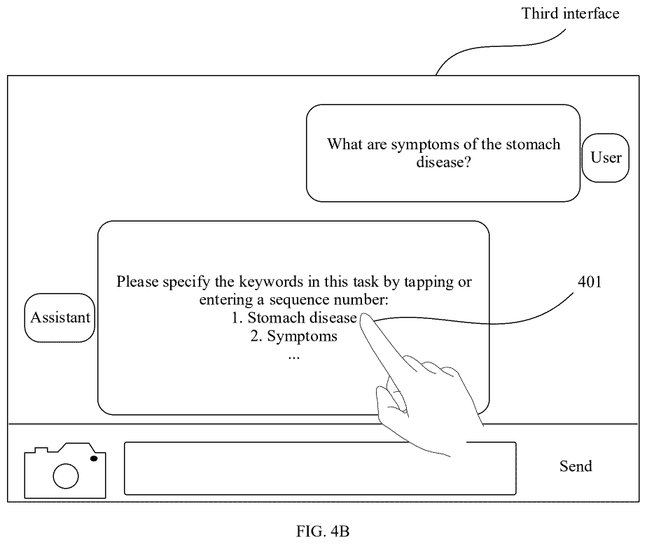

For example, the examples in FIG. 3A to FIG. 3C are still used, and the first keyword is a word in the first request information. As shown in FIG. 4A, the first unit displays a third interface after the user enters the request information, where the third page includes a user window and an assistant window, and the assistant window is used to determine the first keyword in the first request information by interacting with the user. For example, the assistant window in FIG. 4A shows “Please specify the first keyword in the request information in a manner such as tapping or entering a sequence number: 1. Stomach disease 2. Symptoms . . . ”. Further, as shown in FIG. 4B, the first unit determines, in a manner of responding to a tap operation 401 of the user, that first keywords in the first request information include “stomach disease” and “symptoms” (not shown in the figure).

In addition, a quantity of first keywords is not limited in embodiments of this application, and there may be one or more first keywords.

In this embodiment of this application, the first unit obtains the plurality of pieces of second request information based on the first request information and the first keyword in a plurality of manners. The first unit may obtain the plurality of pieces of second request information based on an operation of the user, or the first unit may obtain the plurality of pieces of second request information according to a second preset rule, or the first unit may send the first request information and the first keyword to another device (for example, the third unit), and the another device determines the plurality of pieces of second request information based on the first request information and the first keyword and returns the plurality of pieces of second request information to the first unit (for example, in FIG. 1C, the first unit sends the first request information and the first keyword to the third unit, and the third unit may determine the plurality of pieces of second request information based on the first request information and the first keyword, and send the plurality of pieces of second request information to the first unit). This is not limited herein.

In an embodiment, the first unit first determines a plurality of first replacement words based on the first keyword using the second preset rule, and then separately replaces the first keyword in the first request information with the plurality of first replacement words to obtain the plurality of pieces of second request information. The second preset rule is related to at least one of the following: a synonym, a word of a same type, a scrambled order, multiplication by a random number (for a number), a replacement word related to the first keyword, an antonym, and the like.

Because an objective of this embodiment of this application is to obfuscate the real request information, in addition to the foregoing second preset rule, an obfuscating manner may further be a manner such as table lookup, model generation, manual entry, analogical reasoning, or mathematical solving.

For example, the first request information involves a number sequence such as identification numbers, bank card numbers, and postal codes, and the first keyword includes the number sequence. Determining the plurality of first replacement words based on the first keyword using the second preset rule may include: randomly scrambling numbers in the number sequence or multiplying the numbers by a random number, to obtain the first replacement words. For another example, the first keyword includes a user name, an address, a place of birth, and the like. Determining the plurality of first replacement words based on the first keyword using the second preset rule may include: randomly replacing a word in the first keyword (modifying a family name, an address, a place of birth, or the like).

For example, Example 1 is still used. The first request information is: What are symptoms of the stomach disease? The first keywords include “stomach disease” and “symptoms”. The first unit determines, based on a word of a same type, that replacement words for “stomach disease” include “liver disease” and “kidney disease”, and the first unit determines, based on the replacement words related to the first keyword, that replacement words for “symptoms” include “treatment methods” and “hospitals that offer treatment”. Therefore, a plurality of pieces of second request information obtained by substituting the replacement words into the first request information to replace the corresponding first keywords include: “What are symptoms of the kidney disease?”, “What are symptoms of the liver disease?”, “What are treatment methods for the liver disease?”, and “Which hospitals that offer treatment for the stomach disease?”.

In an embodiment, the first unit sends the first request information and the first keyword to the third unit; the third unit generates the plurality of pieces of second request information based on the first request information and the first keyword; and the first unit receives the plurality of pieces of second request information sent by the third unit. Certainly, alternatively, the first unit may directly send the first request information to the third unit, and the third unit determines the first keyword in the first request information, obtains the plurality of pieces of second request information based on the first keyword, and returns the plurality of pieces of second request information to the first unit.

In a second case, the first unit obtains a plurality of pieces of second request information based on the first response information.

This case may be understood as follows: In this embodiment, the first request information and the plurality of pieces of second request information are carried in different messages, and the first response information and a plurality of pieces of second response information are carried in different messages. In other words, it may be understood as that the first unit may first send the first request information to the second unit, and receive the first response information. Then, the first unit sends the plurality of pieces of second request information to the second unit, and receives the plurality of pieces of second response information.

After obtaining the first request information, the first unit sends the first request information to the second unit. The second unit obtains the first response information over the neural network, and sends the first response information to the first unit. Then, the first unit obtains a plurality of pieces of third response information based on the first response information, and performs reverse inference based on the plurality of pieces of third response information to obtain the plurality of pieces of second request information.

In an embodiment, the first unit may determine a second keyword in the first response information, and obtain the plurality of pieces of third response information based on the second keyword in the first response information. The first unit may alternatively send the first response information to the third unit, and the third unit generates the plurality of pieces of third response information based on the first response information, and returns the third response information to the first unit. A manner of obtaining the plurality of pieces of third response information based on the second keyword is similar to the foregoing manner of obtaining the plurality of pieces of second request information based on the first keyword. Details are not described herein again.

Certainly, alternatively, the first unit may directly perform reverse inference on the plurality of pieces of third response information to obtain the plurality of pieces of second request information, or may send the plurality of pieces of third response information to the third unit, and the third unit performs reverse inference on the plurality of pieces of third response information to obtain the plurality of pieces of second request information, and returns the plurality of pieces of second request information to the first unit. Alternatively, the first unit sends the first response information to the third unit, and the third unit obtains the plurality of pieces of second request information based on the first response information, and then returns the plurality of pieces of second request information to the first unit.

The foregoing reverse inference process may be specified by the user, or may be performed via a text generation network or a preset rule. This is not limited herein. For example, the first unit obtains, via the text generation network, the second request information corresponding to the third response information. The text generation network may be obtained by performing training by using training data as an input and using an objective that a value of a loss function is less than a threshold. The loss function indicates a difference between an output of the text generation network and a label of the training data.

Example 2: The first request information is: How to lose weight when the weight is 100 kilograms? The first response information fed back by the second unit based on the first request information is: Eat less and exercise more. The first unit or the third unit may determine, based on a word of a same type and an antonym, that second keywords in “eat less and exercise more” include “drink more” and “rest more”, determine that a replacement word for “eat less” includes “drink more”, and determine that a replacement word for “exercise more” includes “rest more”. Therefore, a plurality of pieces of second response information obtained by substituting the replacement words into the first response information to replace the corresponding second keywords include: “Drink more and exercise more”, “Drink more and rest more”, “Drink less and rest more”, and the like. In this way, reverse inference is performed on the second response information of “Drink more and exercise more” to obtain second request information of “What should people with kidney stones be aware of?”. The first unit performs reverse inference on the second response information of “Drink more and rest more” to obtain second request information of “What is recommended during the postoperative recovery period?”. The first unit performs reverse inference on the second response information of “Drink less and rest more” to obtain second request information of “How can people avoid sleep problems caused by frequent coffee drinking at night?”.

Operation 206: The first unit sends the plurality of pieces of second request information to the second unit.

After obtaining the plurality of pieces of second request information, the first unit may send the plurality of pieces of second request information to the second unit. Correspondingly, the second unit receives the plurality of pieces of second request information sent by the first unit. The plurality of pieces of request information are used to obfuscate the first request information, so that the second unit cannot determine the real request information, thereby improving user privacy.

In this embodiment of this application, obfuscating the real request information by using the fake request information may also be understood as obscuring the real request information by using the fake request information. Alternatively, it is understood as that, the fake request information and the real request information are mixed, so that an untrusted unit cannot determine/identify the real request information in a plurality of pieces of mixed request information. In this way, the real request information is protected by using the fake request information, and leakage of user privacy in the real request information is reduced.

Operation 207: The second unit obtains the plurality of pieces of second response information over the neural network.

After obtaining the plurality of pieces of second request information, the second unit obtains the plurality of pieces of second response information over the neural network, where the plurality of pieces of second response information correspond to the plurality of pieces of second request information.

For ease of understanding, the foregoing plurality of pieces of second response information may be understood as a plurality of pieces of fake response information.

In this embodiment of this application, the neural network may be a convolutional neural network (CNN), a feedforward neural network (FNN), a recursive neural network (RNN) (for example, a long short-term memory network, a gated recurrent unit, or an attention network), a transformer, a generative adversarial network (GAN), an LLM, or the like. A structure, type, and training manner of the neural network are not limited in embodiments of this application.

In an embodiment, the second unit inputs the plurality of pieces of second request information into the neural network to obtain the plurality of pieces of second response information. It may be understood that the plurality of pieces of second request information may be input a plurality of times, or may be input once. This is not limited herein.

Operation 208: The second unit sends the plurality of pieces of second response information to the first unit.

After obtaining the plurality of pieces of second response information, the second unit sends the plurality of pieces of second response information to the first unit. Correspondingly, the first unit receives the plurality of pieces of second response information sent by the second unit.

Operation 209: The first unit presents response information.

After receiving the first response information and the plurality of pieces of second response information that are sent by the second unit, the first unit may present the response information to the user, where the response information includes the first response information, or includes the plurality of pieces of second response information and the first response information.

In a possible implementation, the first unit directly presents a plurality of pieces of response information to the user, where the plurality of pieces of response information include the first response information and the plurality of pieces of second response information.

In an embodiment, the first unit may further present indication information to the user, where the indication information indicates a location of the first response information in the plurality of pieces of response information. This helps the user determine the real response information.

It may be understood that, the first unit determines the location of the real response information in the plurality of pieces of response information in a plurality of manners. When the first unit sends the first request information and the plurality of pieces of second request information to the second unit, a location of the first request information may be recorded, to determine the location of the first response information in the plurality of pieces of response information. Alternatively, when the first unit sends the first request information and the plurality of pieces of second request information to the second unit, an identifier may be attached to each piece of request information, to subsequently determine the location of the real response information based on the identifier. This is not limited herein.

In an embodiment, the first unit performs some processing (for example, selection, rendering, and format conversion) on the plurality of pieces of response information, and then presents processed response information to the user.

In addition, in this embodiment of this application, the presentation may include at least one of the following: display, voice playing, and the like. For example, the first unit may display the response information to the user, or may present the response information to the user in a voice broadcast manner. A presentation manner is not limited in this application.

It should be noted that there is no time sequence limitation on the operations in this embodiment of this application. The following uses an example for description.

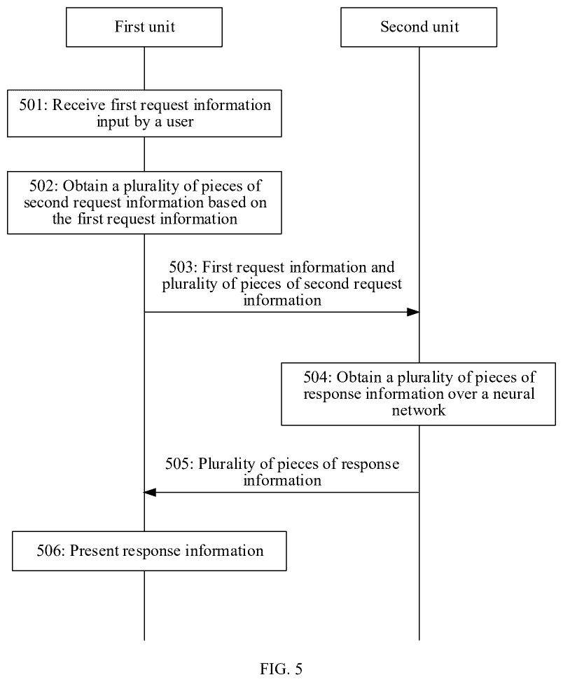

In an embodiment, operation 202 and operation 206 are a same operation (or it is understood as that the first request information in operation 202 and the plurality of pieces of second request information in operation 206 are carried in a same message), operation 203 and operation 207 are a same operation, and operation 204 and operation 208 are a same operation (or it is understood as that the first response information in operation 204 and the plurality of pieces of second response information in operation 208 are carried in a same message). In other words, it may be understood as that the first unit may simultaneously send the first request information and the plurality of pieces of second request information to the second unit, and the second unit may simultaneously send the first response information and the plurality of pieces of second response information to the first unit. In this case, the embodiment shown in FIG. 2 may be described as an embodiment shown in FIG. 5. In other words, the method in the embodiment shown in FIG. 2 may be equivalent to the following operation 501 to operation 506. Operation 501: A first unit receives first request information input by a user. Operation 502: The first unit obtains a plurality of pieces of second request information based on the first request information. Operation 503: The first unit sends the first request information and the plurality of pieces of second request information to a second unit. Operation 504: The second unit obtains a plurality of pieces of response information over a neural network. Operation 505: The second unit sends the plurality of pieces of response information to the first unit. Operation 506: The first unit presents response information. For detailed descriptions of FIG. 5, refer to the foregoing descriptions. Details are not described herein again.

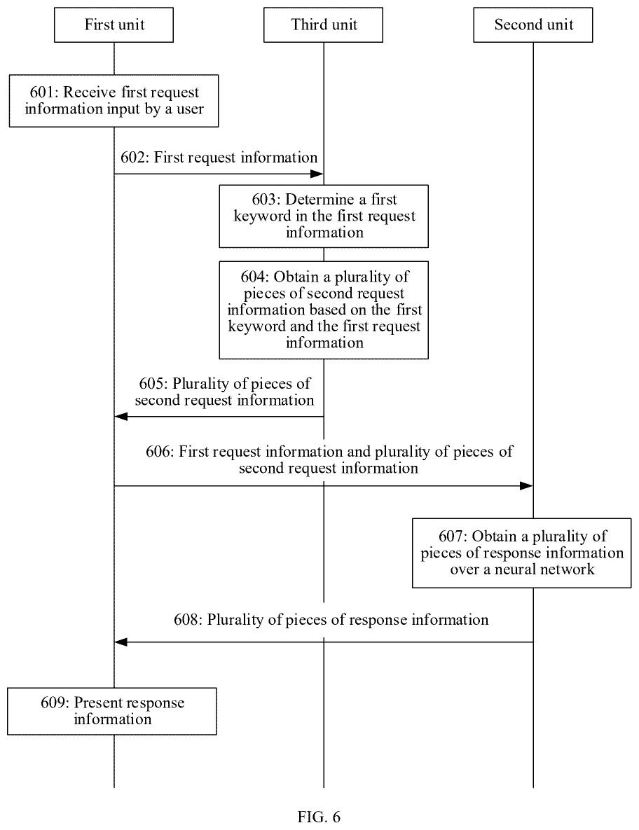

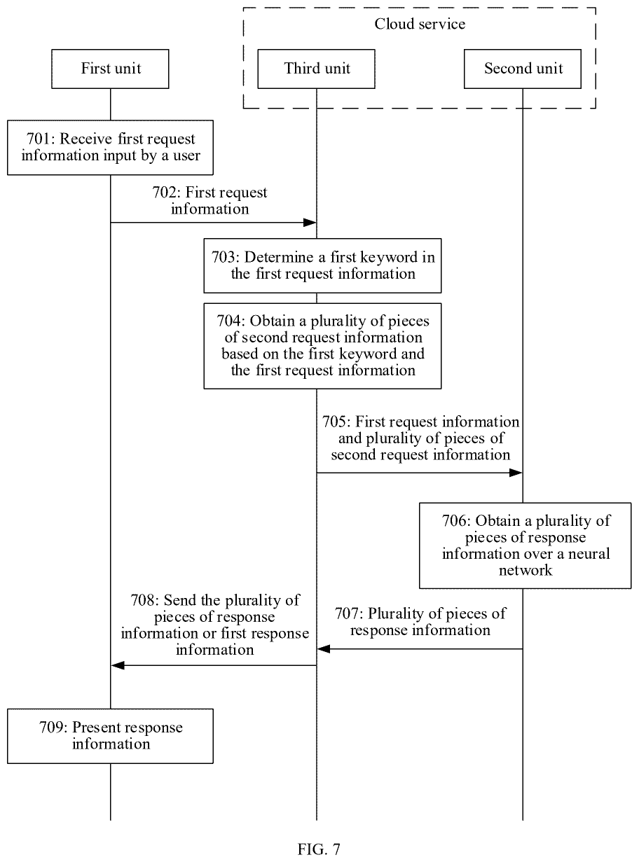

In an embodiment, operation 202 and operation 206 are different operations (or it is understood as that the first request information in operation 202 and the plurality of pieces of second request information in operation 206 are carried in different messages), operation 203 and operation 207 are different operations, and operation 204 and operation 208 are different operations (or it is understood as that the first response information in operation 204 and the plurality of pieces of second response information in operation 208 are carried in different messages). In other words, it may be understood as that the first unit may first send the first request information to the second unit, and receive the first response information. Then, the first unit sends the plurality of pieces of second request information to the second unit, and receives the plurality of pieces of second response information. In this case, the embodiment shown in FIG. 2 may be described as an embodiment shown in FIG. 6 or FIG. 7. In other words, the method in the embodiment shown in FIG. 2 may be equivalent to the following embodiment shown in FIG. 6 or FIG. 7.

In embodiments of this application, a trusted unit (the first unit or the third unit) obtains a plurality of pieces of fake request information corresponding to the real request information, and the first unit may obfuscate the real request information by using the plurality of pieces of fake request information, so that an untrusted unit cannot determine the real request information, thereby improving user privacy protection. In addition, a real answer is first obtained by using the real request information, and then a plurality of fake answers are obtained by obfuscating the real answer, so that reverse inference can be performed on the plurality of fake answers to obtain the plurality of pieces of fake request information. Generally, the second unit retrieves a log or the like in a specified period of time, provided that the second unit infers that a time interval between the real request information and the fake request information is less than the period of time. In terms of log representation, the first unit may obfuscate the real request information by using the plurality of pieces of fake request information, thereby improving user privacy protection.

In an embodiment, when the embodiment shown in FIG. 2 is applicable to the scenario shown in FIG. 1A, the first unit in the embodiment shown in FIG. 2 is the first unit in FIG. 1A, and the second unit in the embodiment shown in FIG. 2 is the second unit in FIG. 1A.

In an embodiment, when the embodiment shown in FIG. 2 is applicable to the scenario shown in FIG. 1B, the first unit in the embodiment shown in FIG. 2 is the first unit in FIG. 1B, and the second unit in the embodiment shown in FIG. 2 is the second unit in FIG. 1B.

In an embodiment, when the embodiment shown in FIG. 2 is applicable to the scenario shown in FIG. 1C, the first unit in the embodiment shown in FIG. 2 is the first unit in FIG. 1C, and the second unit in the embodiment shown in FIG. 2 is the second unit in FIG. 1C. In this case, a manner of obtaining the first request information by the first unit in the embodiment shown in FIG. 2 is a manner of receiving the first request information sent by another device (for example, the third unit), and after obtaining the plurality of pieces of response information, the first unit in the embodiment shown in FIG. 2 sends the plurality of pieces of response information or the first response information to the another device (for example, the third unit).

FIG. 6 is another schematic flowchart of a data processing method according to an embodiment of this application. The method may include operation 601 to operation 609. The following describes operation 601 to operation 609 in detail. The method shown in FIG. 6 may be applied to the system architecture shown in FIG. 1B.

Operation 601: A first unit receives first request information input by a user.

For operation 601 in this embodiment, refer to the descriptions of operation 201 in the embodiment shown in FIG. 2. Details are not described herein again.

Operation 602: The first unit sends the first request information to a third unit.

After obtaining the first request information, the first unit sends the first request information to the third unit. Correspondingly, the third unit receives the first request information sent by the first unit.

Operation 603: The third unit determines a first keyword in the first request information.

Operation 604: The third unit obtains a plurality of pieces of second request information based on the first keyword and the first request information.

For operation 603 and operation 604 in this embodiment, refer to the descriptions of operation 205 in the embodiment shown in FIG. 2. Details are not described herein again.

Operation 605: The third unit sends the plurality of pieces of second request information to the first unit.

After obtaining the plurality of pieces of second request information, the third unit may send the plurality of pieces of second request information to the first unit. Correspondingly, the first unit receives the plurality of pieces of second request information sent by the third unit.

It may be understood that the third unit may alternatively send the first request information and the plurality of pieces of second request information to the first unit. Correspondingly, the first unit receives the first request information and the plurality of pieces of second request information that are sent by the third unit.

Operation 606: The first unit sends the first request information and the plurality of pieces of second request information to a second unit.

Operation 607: The second unit obtains a plurality of pieces of response information over a neural network.

Operation 608: The second unit sends the plurality of pieces of response information to the first unit.

Operation 609: The first unit presents response information.

For operation 606 to operation 609 in this embodiment, refer to the descriptions of operation 202, operation 204, operation 206, operation 208, and operation 209 in the embodiment shown in FIG. 2. Details are not described herein again.

In this embodiment of this application, a third-party device (namely, the third unit) of a trusted unit obtains a plurality of pieces of fake request information corresponding to real request information, and the first unit may obfuscate the real request information by using the plurality of pieces of fake request information, so that an untrusted unit cannot determine the real request information, thereby improving user privacy protection.

FIG. 7 is another schematic flowchart of a data processing method according to an embodiment of this application. The method may include operation 701 to operation 709. The following describes operation 701 to operation 709 in detail. The method shown in FIG. 7 may be applied to the system architecture shown in FIG. 1C.

Operation 701: A first unit receives first request information input by a user.

For operation 701 in this embodiment, refer to the descriptions of operation 201 in the embodiment shown in FIG. 2. Details are not described herein again.

Operation 702: The first unit sends the first request information to a third unit.

After obtaining the first request information, the first unit sends the first request information to the third unit. Correspondingly, the third unit receives the first request information sent by the first unit.

Operation 703: The third unit determines a first keyword in the first request information.

Operation 704: The third unit obtains a plurality of pieces of second request information based on the first keyword and the first request information.

For operation 703 and operation 704 in this embodiment, refer to the descriptions of operation 205 in the embodiment shown in FIG. 2. Details are not described herein again.

Operation 705: The third unit sends the first request information and the plurality of pieces of second request information to a second unit.

After obtaining the plurality of pieces of second request information, the third unit may send the first request information and the plurality of pieces of second request information to the second unit. Correspondingly, the first unit receives the plurality of pieces of second request information sent by the third unit.

In this embodiment, the third unit may directly communicate with the second unit.

Operation 706: The second unit obtains a plurality of pieces of response information over a neural network.

For operation 706 in this embodiment, refer to the descriptions of operation 203 and operation 207 in the embodiment shown in FIG. 2. Details are not described herein again.

Operation 707: The second unit sends the plurality of pieces of response information to the third unit.

After obtaining the plurality of pieces of response information, the second unit may send the plurality of pieces of response information to the third unit. Correspondingly, the third unit receives the plurality of pieces of response information sent by the second unit.

Operation 708: The third unit sends the plurality of pieces of response information or first response information to the first unit.

After receiving the plurality of pieces of response information sent by the second unit, the third unit may send the plurality of pieces of response information or the first response information to the first unit. Correspondingly, the first unit receives the plurality of pieces of response information or the first response information sent by the third unit.

In an embodiment, after obtaining the plurality of pieces of response information, the third unit directly forwards the plurality of pieces of response information to the first unit.

In an embodiment, after obtaining the plurality of pieces of response information, the third unit performs some processing (for example, selection, rendering, and format conversion) on the plurality of pieces of response information, and then sends processed response information to the first unit.

Operation 709: The first unit presents response information.

For operation 709 in this embodiment, refer to the descriptions of operation 209 in the embodiment shown in FIG. 2. Details are not described herein again.

In this embodiment of this application, a trusted unit or device (namely, the third unit) obtains a plurality of pieces of fake request information corresponding to real request information, and the first unit may obfuscate the real request information by using the plurality of pieces of fake request information, so that an untrusted unit cannot determine the real request information, thereby improving user privacy protection.

The foregoing embodiments shown in FIG. 6 and FIG. 7 describe a method for directly replacing a keyword in the real request information to obtain the plurality of pieces of fake request information. The following describes a method for replacing a keyword in real response information to obtain a plurality of fake answers, and then performing reverse inference based on the plurality of fake answers to obtain the plurality of pieces of fake request information.

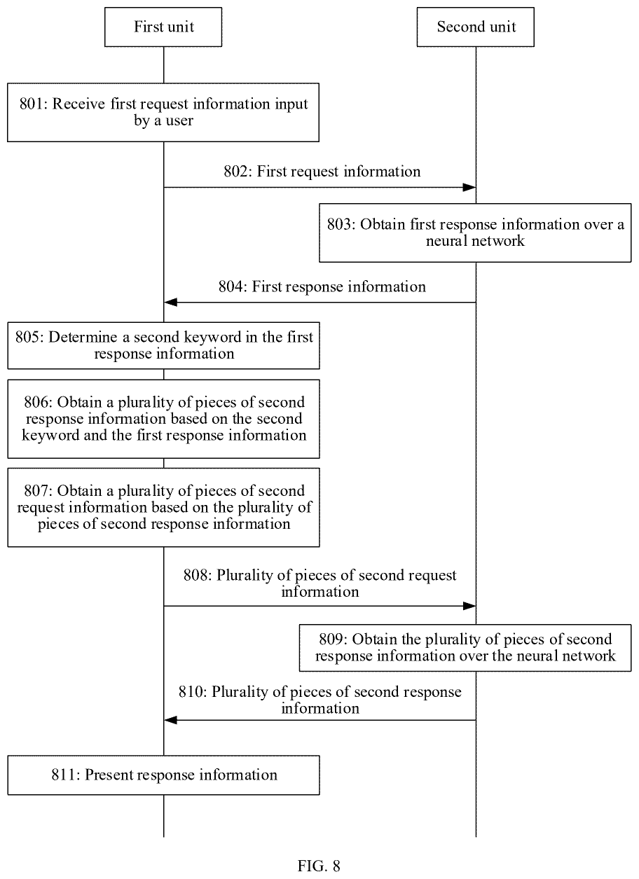

FIG. 8 is another schematic flowchart of a data processing method according to an embodiment of this application. The method may include operation 801 to operation 811. The following describes operation 801 to operation 811 in detail. The method shown in FIG. 8 may be applied to any one of the system architectures shown in FIG. 1A to FIG. 1C.

Operation 801: A first unit receives first request information input by a user.

For operation 801 in this embodiment, refer to the descriptions of operation 201 in the embodiment shown in FIG. 2. Details are not described herein again.

For example, the first request information is: How to lose weight when the weight is 100 kilograms?

Operation 802: The first unit sends the first request information to a second unit.

After obtaining the first request information, the first unit sends the first request information to the second unit. Correspondingly, the second unit receives the first request information sent by the first unit.

Operation 803: The second unit obtains first response information over a neural network.

After receiving the first request information, the second unit obtains the first response information over the neural network.

In an embodiment, the second unit inputs the first request information into the neural network to obtain the first response information.

For the neural network, the first request information, and the first response information in this embodiment, refer to the descriptions in the embodiment shown in FIG. 2. Details are not described herein again.

For example, the foregoing example of the first request information is still used. The first response information is: Eat less and exercise more.

Operation 804: The second unit sends the first response information to the first unit.

After obtaining the first response information, the second unit sends the first response information to the first unit. Correspondingly, the first unit receives the first response information sent by the second unit.

In an embodiment, after obtaining the first response information, the first unit may present the first response information to the user.

Operation 805: The first unit determines a second keyword in the first response information.

After obtaining the first response information, the first unit determines the second keyword in the first response information.

In this embodiment, the first unit determines the second keyword in the first response information in a plurality of manners. The first unit may determine the second keyword based on a selection operation of the user, or may determine the second keyword according to a third preset rule, or may send the first response information to another device (for example, a third unit), and the another device determines the second keyword and returns the second keyword to the first unit. This is not limited herein.

The third preset rule is similar to the first preset rule used to determine the first keyword in the first request information in the embodiment shown in FIG. 2. This is not limited herein.

For example, the examples of the first request information and the first response information are still used, and the first unit may determine, by using a word of a same type and an antonym, that second keywords in “eat less and exercise more” include “drink more” and “rest more”.

Operation 806: The first unit obtains a plurality of pieces of second response information based on the second keyword and the first response information.

After obtaining the keyword, the first unit may obtain the plurality of pieces of second response information based on the keyword and the first response information.

In this embodiment of this application, the first unit obtains the plurality of pieces of second response information in a plurality of manners. The first unit may obtain the plurality of pieces of second response information based on an operation of the user, or may obtain the plurality of pieces of second response information according to a fourth preset rule, or may send the first response information and the second keyword to another device (for example, the third unit), and the another device determines the plurality of pieces of second response information based on the first response information and the second keyword and returns the plurality of pieces of second response information to the first unit. This is not limited herein.

The fourth preset rule is similar to the second preset rule used to obtain the plurality of pieces of second request information in the embodiment shown in FIG. 2. This is not limited herein.

In an embodiment, the first unit first determines a plurality of replacement words based on the second keyword using the fourth preset rule, and then separately replaces the second keyword in the first response information with the plurality of replacement words to obtain the plurality of pieces of second response information.

For example, the examples of the first request information, the first response information, and the second keyword are still used. The first unit determines that a replacement word for “eat less” includes “drink more”, and determines that a replacement word for “exercise more” includes “rest more”. Therefore, a plurality of pieces of second response information obtained by substituting the replacement words into the first response information to replace the corresponding second keywords include: “Drink more and exercise more”, “Drink more and rest more”, “Drink less and rest more”, and the like.

In an embodiment, the first unit sends the first response information and the second keyword to the third unit; the third unit generates the plurality of pieces of second response information based on the first response information and the second keyword; and the first unit receives the plurality of pieces of second response information sent by the third unit. Certainly, alternatively, the first unit may directly send the first response information to the third unit, and the third unit determines the second keyword in the first response information, obtains the plurality of pieces of second response information based on the second keyword, and returns the plurality of pieces of second response information to the first unit.

Operation 807: The first unit obtains a plurality of pieces of second request information based on the plurality of pieces of second response information.

After obtaining the plurality of pieces of second response information, the first unit may perform reverse inference based on the plurality of pieces of second response information to obtain the plurality of pieces of second request information.

The foregoing reverse inference process may be specified by the user, or may be performed via a text generation network or a preset rule. This is not limited herein. For example, the first unit obtains, via the text generation network, the second request information corresponding to the second response information. The text generation network may be obtained by performing training by using training data as an input and using an objective that a value of a loss function is less than a threshold. The loss function indicates a difference between an output of the text generation network and a label of the training data.

In addition, in this embodiment of this application, the first unit obtains the plurality of pieces of second request information in a plurality of manners. The first unit may obtain the plurality of pieces of second request information based on an operation of the user, or may obtain the plurality of pieces of second request information according to a fifth preset rule, or may send the plurality of pieces of second response information to another device (for example, the third unit), and the another device determines the plurality of pieces of second request information based on the plurality of pieces of second response information and returns the plurality of pieces of second request information to the first unit. This is not limited herein.

For example, the example of the plurality of pieces of second response information is still used, and t. The first unit performs reverse inference on the second response information of “Drink more and exercise more” to obtain second request information of “What should people with kidney stones be aware of?”. The first unit performs reverse inference on the second response information of “Drink more and rest more” to obtain second request information of “What is recommended during the postoperative recovery period?”. The first unit performs reverse inference on the second response information of “Drink less and rest more” to obtain second request information of “How can people avoid sleep problems caused by frequent coffee drinking at night?”.

Operation 808: The first unit sends the plurality of pieces of second request information to the second unit.

After obtaining the plurality of pieces of second request information, the first unit sends the plurality of pieces of second request information to the second unit. Correspondingly, the second unit receives the plurality of pieces of second request information sent by the first unit.

Operation 809: The second unit obtains the plurality of pieces of second response information over the neural network.

After obtaining the plurality of pieces of second request information, the second unit obtains the plurality of pieces of second response information over the neural network.

For example, the example of the plurality of pieces of second request information is still used. The second response information corresponding to the second request information of “What should people with kidney stones be aware of?” is: “Drink more and exercise more”. The second response information corresponding to the second request information of “What is recommended during the postoperative recovery period?” is: “Follow the doctor's instructions for medication and rest well”. The second response information corresponding to the second request information of “How can people avoid sleep problems caused by frequent coffee drinking at night?” is: “Drink less coffee and rest more”.

Operation 810: The second unit sends the plurality of pieces of second response information to the first unit.

After obtaining the plurality of pieces of second response information, the second unit may send the plurality of pieces of second response information to the first unit. Correspondingly, the first unit receives the plurality of pieces of second response information sent by the second unit.

Operation 811: The first unit presents response information.

For operation 811 in this embodiment, refer to the descriptions of operation 209 in the embodiment shown in FIG. 2. Details are not described herein again.

In this embodiment, a real answer is first obtained by using real request information, and then a plurality of fake answers are obtained by obfuscating the real answer, so that reverse inference can be performed on the plurality of fake answers to obtain a plurality of pieces of fake request information. Generally, the second unit retrieves a log or the like in a specified period of time, provided that the second unit infers that a time interval between the real request information and the fake request information is less than the period of time. In terms of log representation, the first unit may obfuscate the real request information by using the plurality of pieces of fake request information, thereby improving user privacy protection.

The following uses an example in which request information is a question and a processing module implements a data processing function by using an LLM (that is, the request information is a question, and response information is a reply or an answer corresponding to the question).

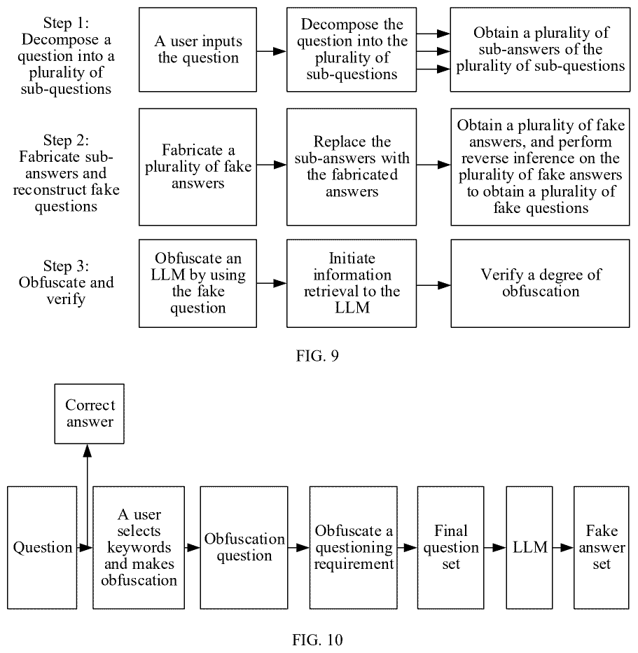

FIG. 9 is another schematic flowchart of a data processing method according to an embodiment of this application.

Operation 1: First, a user enters a question, and then the question is decomposed into a series of sub-questions. Data processing is separately performed on the sub-questions by using a big model to obtain a plurality of corresponding sub-answers.

Operation 2: For the obtained sub-answers, search for words of a same type (for example, synonyms or near-synonyms, where information such as numbers can be replaced or randomly scrambled) of the sub-answers, then randomly combine these sub-answers to obtain a plurality of fake answers, and perform reverse inference on the plurality of fake answers to obtain a plurality of fake questions.

Operation 3: Obfuscate and verify: Obfuscate the LLM by using the plurality of fake questions, initiate information retrieval to the LLM, and verify an obfuscation degree.

The method provided in embodiments of this application is described.

FIG. 10 is another schematic flowchart of a data processing method according to an embodiment of this application. The method is applied to an encoding processing module, which may be a program for automatically processing a natural language, or may be of another type. This is not limited herein.

A question is obtained, the question is input into an LLM, and an answer is replied. The question is input into the encoding processing module. The module is located on a user side, words that may be related to user privacy and that exist in the question are first identified (which may be automatically identified by an encoder, or may be manually selected by a user through tapping), and these words (which may also be referred to as keywords) are modified (including but not limited to replacing the words with synonyms/words of a same type, and randomly scrambling/changing information such as numbers), to generate a series of obfuscation questions. For each generated question, the LLM is required to generate an answer. A fake answer is mixed with a previous correct answer, to obfuscate the model.

For example, the question is: “What are symptoms of the stomach disease?”, keywords include “stomach disease” and “symptoms”, and several generated obfuscation questions include: “What are symptoms of the stomach disease?”, “What are symptoms of the kidney disease?”, “What are symptoms of the liver disease?”, “What are treatment methods for the liver disease?”, and “What are treatment methods for the stomach disease?”. A final question set includes: “What are treatments methods for the liver disease?” corresponding to three incorrect answers, “What are symptoms of the stomach disease?” corresponding to one correct answer, and “Which hospitals offer treatment for the kidney disease” corresponding to two random answers.

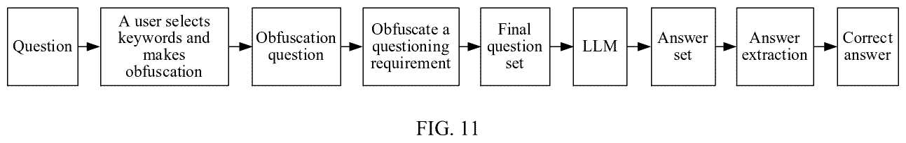

FIG. 11 is another schematic flowchart of a data processing method according to an embodiment of this application. The method is applied to an encoding processing module and a decoding processing module. The encoding processing module and the decoding processing module may be programs for automatically processing a natural language, or may be of another type. This is not limited herein.

A question is input into the encoding processing module. The module is located on a user side, words that may be related to user privacy and that exist in the question are first identified (which may be automatically identified by an encoder, or may be manually selected by a user through tapping), and these words are modified (including but not limited to replacing the words with synonyms/words of a same type, and randomly scrambling/changing information such as numbers), to generate a series of obfuscation questions.

For each generated question, an LLM is required to generate several answers, and agrees on a location in a prompt by using a command, to specify that an answer at the location is a correct answer, and the other answers are incorrect answers. The LLM performs inference to generate a series of answers.

The corresponding answers generated by the large model are input into the decoding processing module (where the module is also located on the user side), and the correct answer of the real question is extracted and presented to the user based on the agreed location.

For example, the question is: “What are symptoms of the stomach disease?”, keywords include “stomach disease” and “symptoms”, and several generated obfuscation questions include: “What are symptoms of the stomach disease?”, “What are symptoms of the kidney disease?”, “What are symptoms of the liver disease?”, “What are treatment methods for the liver disease?”, and “What are treatment methods for the stomach disease?”. A final question set includes: “What are treatments methods for the liver disease?” corresponding to three incorrect answers, “What are symptoms of the stomach disease?” corresponding to one correct answer, and “Which hospitals offer treatment for the kidney disease” corresponding to two random answers.

It can be learned that, compared with the embodiment shown in FIG. 10, in this embodiment, the decoding processing module is added in the method, but a correct question and answer no longer appear at the beginning, which is conducive to further protection of privacy.

In this embodiment of this application, obfuscation is performed on a question a plurality of times for privacy protection. For example, a user asks a question in an interaction interface, and asks a plurality of questions in a privacy mode. A manner of generating an obfuscation question is not limited, to provide better protection. The obfuscation question may be generated in a manner such as a random manner, table lookup, model generation, manual entry, analogical reasoning, or mathematical solving manner. In addition, an algorithm process of generating the obfuscation question based on prompts is as follows: The user asks a question in the interaction interface, and a group of prompts are attached in the privacy mode. A particular text format of the prompt is not limited, provided that the prompt can be used to generate a fake question.

The present invention hides, through obfuscation, a real question and answer in a large quantity of questions and answers (namely, fake questions and fake answers) that are related to but different from each other.

For an untrusted LLM provider that mainly aims to access privacy data, this method can prevent automatic capture scripts from capturing and selecting the real question and real answer, thereby protecting privacy.

For an untrusted LLM provider that uses user question and answer data as data used for further model training, a large quantity of conflicting questions and answers are used to reduce accuracy of model training based on opposite gradients, thereby preventing private data of a user from appearing in other inference after being trained, and protecting user privacy.

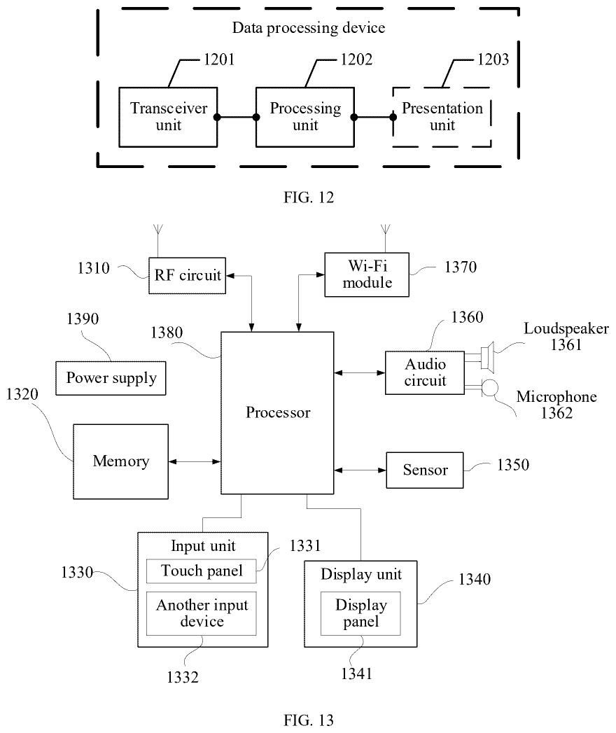

The foregoing describes the data processing method in embodiments of this application, and the following describes devices in embodiments of this application. Refer to FIG. 12. An embodiment of the data processing devices in embodiments of this application includes: a transceiver unit 1201 and a processing unit 1202.

In an embodiment, the data processing device shown in FIG. 12 is the first device in embodiments shown in FIG. 1A to FIG. 11, and functions of the units are as follows.

The transceiver unit 1201 is configured to send, to a second unit, first request information input by a user.

The transceiver unit 1201 is further configured to receive, from the second unit, first response information corresponding to the first request information.

The transceiver unit 1201 is further configured to send second request information to the second unit, where the second request information is used to obfuscate the first request information.

The transceiver unit 1201 is further configured to receive, from the second unit, second response information corresponding to the second request information.

In an embodiment, the first device further includes the processing unit 1202, configured to obtain the second request information based on the first request information.

In an embodiment, the processing unit 1202 is configured to determine a first keyword in the first request information; and the processing unit 1202 is configured to obtain the second request information based on the first keyword and the first request information.

In an embodiment, the processing unit 1202 is configured to determine a first replacement word corresponding to the first keyword; and the processing unit 1202 is configured to replace the first keyword in the first request information with the first replacement word to obtain the second request information.

In an embodiment, the processing unit 1202 is configured to send the first keyword and the first request information to a third unit; and the processing unit 1202 is configured to receive the second request information sent by the third unit.

In an embodiment, the processing unit 1202 is configured to determine the first keyword based on a first operation of the user or a first preset rule.

In an embodiment, the processing unit 1202 is configured to send the first request information to a third unit; and the processing unit 1202 is configured to receive the second request information sent by the third unit.

In an embodiment, the first device further includes the processing unit 1202, configured to generate the second request information based on the first response information.

In an embodiment, the processing unit 1202 is configured to obtain third response information based on the first response information; and the processing unit 1202 is configured to obtain the second request information based on the third response information.

In an embodiment, the processing unit 1202 is configured to determine a second keyword in the first response information; the processing unit 1202 is configured to determine a second replacement word corresponding to the second keyword; and the processing unit 1202 is configured to replace the second keyword in the first response information with the second replacement word to obtain the third response information.

In an embodiment, the first device further includes a presentation unit 1203, configured to present a plurality of pieces of response information or the first response information to the user, where the plurality of pieces of response information include the first response information and the second response information.

In an embodiment, the transceiver unit 1201 is further configured to receive the first request information sent by a third unit; and the transceiver unit 1201 is further configured to send a plurality of pieces of response information or the first response information to the third unit, where the plurality of pieces of response information include the first response information and the second response information.

In an embodiment, the first device is a question-answering device.

In an embodiment, the first request information includes at least one of the following: a question, a word processing request, and a translation request.

In this embodiment, operations performed by the units in the data processing device are similar to the descriptions of the first unit in embodiments shown in FIG. 1A to FIG. 11. Details are not described herein again.

In this embodiment, a trusted unit or device (the first unit or the third unit) obtains fake request information, and the processing unit 1202 obfuscates real request information by using the fake request information, so that an untrusted unit cannot determine the real request information, thereby improving user privacy protection.

In an embodiment, the data processing device shown in FIG. 12 is the third device in embodiments shown in FIG. 1A to FIG. 11, and functions of the units are as follows.

The transceiver unit 1201 is configured to receive first request information sent by a first unit or first response information corresponding to the first request information.

The transceiver unit 1201 is further configured to send second request information to the first unit based on the first request information or the first response information, where the second request information is used to obfuscate the first request information.

In an embodiment, the third device is deployed on a network server, and the first unit is deployed on a terminal device.

In an embodiment, the transceiver unit 1201 is configured to obtain the second request information based on the first request information or the first response information; and the transceiver unit 1201 is configured to send the second request information to the first unit.

In this embodiment, operations performed by the units in the data processing device are similar to the descriptions of the third unit in embodiments shown in FIG. 1A to FIG. 11. Details are not described herein again.

In this embodiment, the transceiver unit 1201 in a trusted unit or device (the third device) sends the second request information to the first unit based on the first request information or the first response information, and the first unit may obfuscate real request information by using fake request information, thereby improving user privacy protection.

In an embodiment, the data processing device shown in FIG. 12 is the third device in embodiments shown in FIG. 1A to FIG. 11, and functions of the units are as follows.

The transceiver unit 1201 is configured to receive second response information sent by a first unit.

The processing unit 1202 is configured to obtain second request information based on the second response information.

The transceiver unit 1201 is further configured to send the second request information to the first unit, where the second request information is used by a second unit to obtain the second response information corresponding to the second request information.

In this embodiment, operations performed by the units in the data processing device are similar to the descriptions of the third unit in embodiments shown in FIG. 1A to FIG. 11. Details are not described herein again.

In this embodiment, the transceiver unit 1201 performs reverse inference based on fake response information to obtain fake request information. Generally, a second device retrieves a log or the like in a specified period of time, provided that the second device infers that a time interval between the real request information and the fake request information is less than the period of time. In terms of log representation, the transceiver unit 1201 may obfuscate a neural network in an untrusted unit (namely, the second device) by using the fake request information, thereby improving user privacy protection.

Refer to FIG. 13. An embodiment of this application provides another data processing device. The data processing device may be the first device in embodiments shown in FIG. 1A to FIG. 11. For ease of description, only a part related to embodiments of this application is shown. For technical details that are not disclosed, refer to the method part in embodiments of this application. For example, the first device is a mobile phone.

FIG. 13 is a block diagram of a part of a structure of a mobile phone related to the first device provided in this embodiment of this application. Refer to FIG. 13. The mobile phone includes components such as a radio frequency (RF) circuit 1310, a memory 1320, an input unit 1330, a display unit 1340, a sensor 1350, an audio circuit 1360, a wireless fidelity (Wi-Fi) module 1370, a processor 1380, and a power supply 1390. A person skilled in the art may understand that the structure of the mobile phone shown in FIG. 13 does not constitute a limitation on the mobile phone, and the mobile phone may include more or fewer components than those shown in the figure, or combine some components, or have a different component arrangement.

The following describes the components of the mobile phone with reference to FIG. 13.

The RF circuit 1310 may be configured to receive and send a signal in an information receiving and sending process or a call process. In particular, after receiving downlink information from a base station, the RF circuit 1310 sends the downlink information to the processor 1380 for processing. In addition, the RF circuit 1310 sends related uplink data to the base station. Generally, the RF circuit 1310 includes but is not limited to an antenna, at least one amplifier, a transceiver, a coupler, a low noise amplifier (LNA), a duplexer, and the like. In addition, the RF circuit 1310 may further communicate with a network and another device through wireless communication. The foregoing wireless communication may use any communication standard or protocol, including but not limited to a global system for mobile communications (GSM), a general packet radio service (GPRS), code division multiple access (CDMA), wideband code division multiple access (WCDMA), long term evolution (LTE), an email, a short messaging service (SMS), and the like.

The memory 1320 may be configured to store a software program and a module. The processor 1380 executes various function applications of the mobile phone and processes data by running the software program and the module stored in the memory 1320. The memory 1320 may mainly include a program storage area and a data storage area. The program storage area may store an operating system, an application program required for at least one function (such as a sound playback function and an image playback function), and the like. The data storage area may store data (such as audio data and a phone book) created according to use of the mobile phone, and the like. In addition, the memory 1320 may include a high-speed random access memory, and may further include a nonvolatile memory, for example, at least one magnetic disk storage device, a flash storage device, or another volatile solid-state storage device.

The input unit 1330 may be configured to receive input digital or character information, and generate a key signal input related to a user setting and function control of the mobile phone. In an embodiment, the input unit 1330 may include a touch panel 1331 and another input device 1332. The touch panel 1331 is also referred to as a touchscreen, and can collect a touch operation (for example, an operation performed by a user on the touch panel 1331 or near the touch panel 1331 by using any suitable object or accessory such as a finger or a stylus) performed by the user on or near the touch panel 1331, and drive a corresponding connection apparatus according to a preset program. In an embodiment, the touch panel 1331 may include two parts: a touch detection apparatus and a touch controller. The touch detection apparatus detects a touch direction of the user, detects a signal brought by the touch operation, and transmits the signal to the touch controller. The touch controller receives touch information from the touch detection apparatus, converts the touch information into touch point coordinates, then sends the coordinates to processor 1380, and can receive and execute a command sent by the processor 1380. In addition, the touch panel 1331 may be implemented in a plurality of types, such as a resistive type, a capacitive type, an infrared type, and a surface acoustic wave type. In addition to the touch panel 1331, the input unit 1330 may further include the another input device 1332. In an embodiment, the another input device 1332 may include but is not limited to one or more of a physical keyboard, a function key (for example, a volume control button or an on/off button), a mouse, a joystick, and the like.

The display unit 1340 may be configured to display information input by the user or information provided for the user and various menus of the mobile phone. The display unit 1340 may include a display panel 1341. In an embodiment, the display panel 1341 may be configured by using a liquid crystal display (LCD), an organic light-emitting diode (OLED), or the like. Further, the touch panel 1331 may cover the display panel 1341. After detecting the touch operation on or near the touch panel 1331, the touch panel 1331 transmits the touch operation to the processor 1380 to determine a type of a touch event, and then the processor 1380 provides a corresponding visual output on the display panel 1341 based on the type of the touch event. Although in FIG. 13, the touch panel 1331 and the display panel 1341 are used as two separate components to implement input and output functions of the mobile phone, in some embodiments, the touch panel 1331 may be integrated with the display panel 1341 to implement the input and output functions of the mobile phone.

The mobile phone may further include at least one sensor 1350 such as a light sensor, a motion sensor, or another sensor. In an embodiment, the light sensor may include an ambient light sensor and a proximity sensor. The ambient light sensor may adjust luminance of the display panel 1341 according to brightness of ambient light. The proximity sensor may turn off the display panel 1341 and/or backlight when the mobile phone moves to an ear. As a type of motion sensor, an accelerometer sensor may detect a value of acceleration in each direction (usually on three axes), may detect a value and a direction of gravity in a stationary state, and may be used in an application for identifying a mobile phone posture (such as screen switching between a landscape mode and a portrait mode, a related game, or magnetometer posture calibration), a function related to vibration identification (such as a pedometer or a knock), or the like. Other sensors such as a gyroscope, a barometer, a hygrometer, a thermometer, or an infrared sensor may be further configured in the mobile phone. Details are not described herein.

An audio circuit 1360, a loudspeaker 1361, and a microphone 1362 may provide an audio interface between the user and the mobile phone. The audio circuit 1360 can transmit, to the loudspeaker 1361, an electrical signal obtained by converting received audio data, and the loudspeaker 1361 converts the electrical signal into an acoustic signal and outputs the acoustic signal. In addition, the microphone 1362 converts a collected acoustic signal into an electrical signal; the audio circuit 1360 receives the electrical signal and converts the electrical signal into audio data, and outputs the audio data to the processor 1380 for processing; and processed audio data is sent to, for example, another mobile phone through the RF circuit 1310, or audio data is output to the memory 1320 for further processing. In this embodiment of this application, the audio circuit 1360, the loudspeaker 1361, and the microphone 1362 may cooperate to present response information to the user, for example, present the response information to the user in a voice broadcast manner.

Wi-Fi belongs to a short-distance wireless transmission technology. The Wi-Fi module 1370 is used by the mobile phone to help the user receive and send an email, browse a web page, access streaming media, and the like. The Wi-Fi module 1370 provides wireless access to the broadband Internet for the user. Although FIG. 13 shows the Wi-Fi module 1370, it may be understood that the Wi-Fi module 1370 is not a mandatory component of the mobile phone.

The processor 1380 is a control center of the mobile phone, and connects various components of the entire mobile phone through various interfaces and lines. The processor 1380 executes various functions of the mobile phone and processes data by running or executing the software program and/or the module stored in the memory 1320 and invoking data stored in the memory 1320, to monitor the entire mobile phone. In an embodiment, the processor 1380 may include one or more processing units. Preferably, an application processor and a modem processor may be integrated in the processor 1380. The application processor mainly processes an operating system, a user interface, an application program, and the like, and the modem processor mainly processes radio communication. It may be understood that the modem processor may alternatively not be integrated into the processor 1380.

The mobile phone further includes the power supply 1390 (for example, a battery) that supplies power to various components. Preferably, the power supply may be logically connected to the processor 1380 by using a power management system, to implement functions such as charge management, discharge management, and power consumption management by using the power management system.

Although not shown in the figure, the mobile phone may further include a camera, a Bluetooth module, and the like. Details are not described herein.

In this embodiment of this application, the processor 1380 may perform functions of the first unit in embodiments shown in FIG. 1A to FIG. 11. Details are not described herein again.

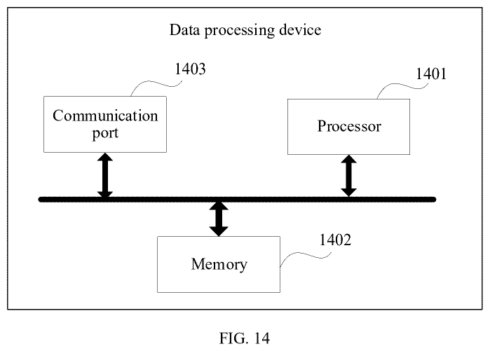

FIG. 14 is a diagram of a structure of another data processing device according to this application. The data processing device may be the second device or the third device in embodiments shown in FIG. 1A to FIG. 11.

The data processing device may include a processor 1401, a memory 1402, and a communication port 1403. The processor 1401, the memory 1402, and the communication port 1403 are interconnected through a line. The memory 1402 stores program instructions and data.

The memory 1402 stores program instructions and data that correspond to the operations performed by the data processing device in the corresponding embodiments shown in FIG. 1A to FIG. 11.

The processor 1401 is configured to perform the operations performed by the data processing device in any one of embodiments shown in FIG. 1A to FIG. 11.

The communication port 1403 may be configured to receive and send data, and is configured to perform operations related to obtaining, sending, and receiving in any one of embodiments shown in FIG. 1A to FIG. 11.

In an embodiment, the data processing device may include more or fewer components than those in FIG. 14. This is merely an example for description in this application, and is not limited.

A person of ordinary skill in the art may be aware that, in combination with the examples described in embodiments disclosed in this specification, units and algorithm operations can be implemented by electronic hardware, computer software, or a combination thereof. To clearly describe the interchangeability between the hardware and the software, the foregoing has generally described compositions and operations of each example based on functions. Whether the functions are performed by hardware or software depends on particular applications and design constraint conditions of the technical solutions. A person skilled in the art may use different methods to implement the described functions for each particular application, but it should not be considered that the manner of implement goes beyond the scope of this application.

It may be clearly understood by a person of ordinary skill in the art that, for ease and brief description, for a detailed working process of the foregoing system, apparatuses, and units, refer to a corresponding process in the foregoing method embodiments. Details are not described herein again.

In the several embodiments provided in this application, it should be understood that the disclosed system, apparatus, and method may be implemented in other manners. For example, division into the units is merely logical function division and may be another division in actual performance of the described operations. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in an electronic form, a mechanical form, or another form.

The units described as separate parts may or may not be physically separate, and parts displayed as units may or may not be physical units, may be located in one position, or may be distributed on a plurality of network units. Some or all of the units may be selected according to actual requirements to achieve the objectives of the solutions of embodiments in this application.

In addition, function units in embodiments of this application may be integrated into one processing unit, each of the units may exist alone physically, or two or more units may be integrated into one unit. The integrated unit may be implemented in a form of hardware, or may be implemented in a form of a software functional unit.

When the integrated unit is implemented in the form of the software functional unit and sold or used as an independent product, the integrated unit may be stored in a computer-readable storage medium. Based on such an understanding, the technical solutions in this application essentially, or the part contributing to the conventional technology, or all or some of the technical solutions may be represented in a form of a software product. The computer software product is stored in a storage medium and includes several instructions for instructing a computer device (which may be a personal computer, a server, a network device, or the like) to perform all or some of the operations of the methods described in embodiments of this application. The foregoing storage medium includes: any medium that can store program code, such as a USB flash disk, a removable hard disk, a read-only memory, a random access memory, a magnetic disk, or an optical disc.

The foregoing descriptions are merely embodiments of this application, but are not intended to limit the protection scope of this application. Any equivalent modification or replacement readily figured out by a person skilled in the art within the technical scope disclosed in this application shall fall within the protection scope of this application. Therefore, the protection scope of this application shall be subject to the protection scope of the claims.

1. A data processing method, performed by a first device that is coupled to a computer network, the method comprising:
sending over the computer network, to a second device, first request information input by a user; and
receiving over the computer network, from the second device, first response information corresponding to the first request information;
determining second request information based on the first request information or based on the first response information;
sending over the computer network, second request information to the second device, wherein sending the second request information to the second device obfuscates an association between the user and the first request information; and
receiving over the computer network, from the second device, second response information corresponding to the second request information.

2. The method according to claim 1, wherein the first device comprises a trusted device, and the second device comprises an untrusted device coupled to the computer network.

3. The method according to claim 1, wherein the determining the second request information based on the first request information comprises:
analyzing the first request information to extract a first keyword in the first request information; and
determining the second request information based on the first keyword and the first request information.

4. The method according to claim 3, wherein the determining the second request information based on the first keyword and the first request information comprises:
determining a first replacement word corresponding to the first keyword; and
replacing the first keyword in the first request information with the first replacement word to obtain the second request information.

5. The method according to claim 3, wherein the determining the second request information based on the first keyword and the first request information comprises:
sending the first keyword and the first request information to a third device; and
receiving the second request information from the third device, wherein the third device is a trusted device.

6. The method according to claim 3, wherein the determining the first keyword in the first request information comprises:
determining the first keyword based on a first operation of the user or a first preset rule.

7. The method according to claim 2, wherein the determining the second request information based on the first request information comprises:
sending the first request information to a third device; and
receiving the second request information from the third device.

8. The method according to claim 1, wherein the first response information and the second response information are respectively generated by the second device using machine learning to process the first request information and the second request information and wherein sending the second request information reduces a training accuracy of the machine learning in association with the first response information and the user.

9. The method according to claim 1, wherein the determining the second request information based on the first response information comprises:
generating third response information based on the first response information; and
determining the second request information by reverse inference from the third response information.

10. The method according to claim 9, wherein the generating the third response information based on the first response information comprises:
determining a second keyword in the first response information;
determining a second replacement word corresponding to the second keyword; and
replacing the second keyword in the first response information with the second replacement word to generate the third response information.

11. The method according to claim 1, wherein the method further comprises:
presenting, to the user, the first response information or presenting both the first response information and the second response information.

12. The method according to claim 1, wherein the method further comprises:
receiving the first request information from a third device; and
sending the first response information or the first response information and the second response information to the third device.

13. The method according to claim 1, wherein the first device is a question-answering device that is configured to receive the first request information from the user through a user interface and display the first response information to the user through the user interface.

14. The method according to claim 1, wherein the first request information comprises at least one of the following: a question, a word processing request, or a translation request.

15. A first device, comprising at least one processor, wherein the at least one processor is coupled to a memory, the memory is configured to store a program or instructions, and when the program or the instructions are executed by the at least one processor, the first device is caused to:
send over a computer network, to a second device, first request information input by a user; and
receive over the computer network, from the second device, first response information corresponding to the first request information;
determine second request information based on the first request information or based on the first response information;
send over the computer network, second request information to the second device, wherein to send the second request information to the second device obfuscates an association between the user and the first request information; and
receive over the computer network, from the second device, second response information corresponding to the second request information.

16. The first device according to claim 15, the first device comprises a trusted device, and the second device comprises an untrusted device coupled to the computer network.

17. The first device according to claim 15, wherein the first device is a terminal device.

18. A non-transitory computer-readable medium storing instructions that, when executed by a processor of a first device, causes the first device to:
send over a computer network, to a second device, first request information input by a user; and
receive over the computer network, from the second device, first response information corresponding to the first request information;
determine second request information based on the first request information or based on the first response information;
send over the computer network to the second device, second request information, wherein sending the second request information to the second device obfuscates an association between the user and the first request information; and
receive over the computer network, from the second device, second response information corresponding to the second request information.

19. The non-transitory computer readable medium according to claim 18, wherein the first device comprises a trusted device, and the second device comprises an untrusted device coupled to the computer network.

20. The non-transitory computer-readable medium according to claim 18, wherein the first device is a question-answering device that is configured to receive the first request information from the user through a user interface and display the first response information to the user through the user interface.
